(19) United States
(12) Patent Application Publication
(10) Pub. No.: US 2026/0025016 A1
(43) Pub. Date: Jan. 22, 2026

(54) CHARGING DEVICE

(71) Applicant: Luxshare precision accessory (Suzhou) Ltd., Suzhou City (CN)

(72) Inventors: Hao Huang, Suzhou City (CN); Gang Huang, Suzhou City (CN); Shengxun Qin, Suzhou City (CN)

(73) Assignee: Luxshare precision accessory (Suzhou) Ltd., Suzhou City (CN)

(21) Appl. No.: 19/265,450

(22) Filed: Jul. 10, 2025

(30) Foreign Application Priority Data
Jul. 17, 2024 (CN) 202410961557.5
Jul. 17, 2024 (CN) 202410962153.8

(51) Int. Cl. H02J 7/00

(52) U.S. Cl. CPC H02J 7/0044

(57) ABSTRACT

A charging device, setting the electrical contacting area in the containing groove. When the earphone is set in the containing groove, the electrical contacting area may be butted together with the contact to charge the earphone. Therefore, two contacting plates are respectively arranged on the opposite sides of two mounting blocks, and the electrical connection position of the electrical contacting area is led out to the outside of the containing groove by the connecting portion.

### CLAIM OF PRIORITY AND CROSS-REFERENCE TO RELATED APPLICATION(S)

This application claims the benefits of Chinese Patent Application No. 202410961557.5, filed on Jul. 17, 2024, and Chinese Patent Application No. 202410962153.8, filed on Jul. 17, 2024, which are incorporated herein by reference in their entireties.

### BACKGROUND OF THE DISCLOSURE

### 1. Field of the Disclosure

The present disclosure relates to the field of electronic device technology, and particularly to a charging device.

### 2. Description of the Related Art

Bluetooth earphones are charged by charging stations. When a charging station is assembled, it needs to connect conductive sheet with feeding circuit in advance. To ensure that after the charging station is assembled, the conductive sheet may touch the contact of earphones and charge them. However, the internal space of the charging station and the volume of the conductive sheet is small, bringing difficulties to the component of the charging station.

### BRIEF DESCRIPTION OF THE DISCLOSURE

In view of this, the embodiment of the disclosure provides a charging device, in which contacting plates are respectively arranged on two mounting blocks, so that two contacting plates are spaced and remain electrically connected with two electrical contacting areas.

According to the first aspect of the embodiment of the disclosure, a charging device is provided, which comprising: a bearing structure comprising a housing portion, the housing portion having a containing groove; and a power supply component comprising a conductive arm, a connecting portion, and a feeding portion, the conductive arm comprising an electrical contacting area in an extending direction, the electrical contacting area being exposed on an inner side of the containing groove, the connecting portion comprising two contacting plates, the two contacting plates being electrically connected to two electrical contacting areas respectively, the feeding portion comprising two paired feeding spring sheets, the two feeding spring sheets being disposed between the two contacting plates, the two feeding spring sheets being electrically lapped with the two contacting plates respectively, and the two feeding spring sheets being curved toward opposite sides and spaced apart.

Further, the feeding portion further comprises: a circuit board comprising multiple feeding areas, the feeding spring sheets being vertically disposed on the feeding areas; wherein the feeding spring sheets comprise sixth curved segments, cach sixth curved segment has an abutting surface, two sixth curved segments are curved in directions away from each other; in a free state of the feeding spring sheets, a spacing between two abutting surfaces is greater than a spacing between the two contacting plates, the two abutting surfaces are in an abutting state with the two contacting plates respectively, and the two feeding spring sheets are curved and deformed toward opposite sides.

Further, the connecting portion further comprises two strip-shaped conductors, each strip-shaped conductor comprises a first connecting end, a second connecting end, and an extending section located between the first connecting end and the second connecting end; two extending sections are attached to different regions of an outer side surface of the housing portion, two first connecting ends are connected to the two contacting plates respectively, and two second connecting ends are electrically connected to the two electrical contacting areas respectively.

Further, the bearing structure further comprises two mounting blocks and multiple positioning members, the two mounting blocks are projected on the outer side surface of the housing portion, the two mounting blocks are oppositely arranged, the multiple positioning members are projected on the two mounting blocks, each positioning member comprises a column and multiple flanges, the multiple flanges are projected on a lateral side of the column; the two contacting plates are disposed on opposite sides of the two mounting blocks and spaced apart, the first connecting end has a positioning hole, the column extends into the positioning hole, and the multiple flanges are clamped on an edge of the positioning hole.

Further, the containing groove has an open end; cach mounting block has a first mounting surface, a second mounting surface, and an edge rib located between the first mounting surface and the second mounting surface, two first mounting surfaces are oppositely arranged, a direction of the second mounting surface is opposite to a direction of the open end, the edge rib is disposed on a side of the first mounting surface close to the circuit board; the first connecting end is disposed on the second mounting surface, the two contacting plates are disposed on the two first mounting surfaces respectively, and edges of each contacting plate cover at least a portion of corresponding edge rib and extend to the first connecting end; each sixth curved segment further comprises a guiding inclined surface, the guiding inclined surface is located on a side of the abutting surface away from the circuit board, two guiding inclined surfaces are inclined toward opposite sides, and in the free state of the feeding spring sheets, a spacing between the two guiding inclined surfaces is the same as a spacing between the contacting plates located at two edge ribs.

Further, the power supply component comprises two conductive arms, the conductive arm further comprises a fixing section and a feeding end, the fixing section is located between the electrical contacting area and the feeding end, the fixing section is fixedly connected to the bearing structure; in a free state of the conductive arm, an end of the conductive arm provided with the electrical contacting area extends into the containing groove, the feeding end and the second connecting end are located on a side of the bearing structure away from the open end, and the second connecting end is electrically connected to the feeding end.

Further, the housing portion further comprises a positioning concavity, the positioning concavity is opposite to a direction of the containing groove; the charging device further comprises a positioning portion, the fixing section is disposed in the positioning concavity via the positioning portion, the positioning portion is an injection-molded part, the fixing section is disposed within the positioning portion, and the feeding end extends out from the positioning portion.

Further, a side of the positioning portion close to the open end is attached to a bottom surface of the positioning concavity, a side away from the open end forms an adhesive groove with the positioning concavity, and the feeding end extends from an inner side to an outer side of the adhesive groove; the charging device further comprises an adhesive, the adhesive fills the adhesive groove.

Further, the connecting portion further comprises multiple solder blocks; wherein a top of the cured adhesive is flush with a top of the adhesive groove; the second connecting end has a connecting hole, the second connecting end extends from a top edge of the adhesive groove to the top of the adhesive, the connecting hole is sleeved on the feeding end, the second connecting end is fixedly connected to the adhesive and the feeding end via the solder blocks, and the second connecting end is electrically connected to the feeding end.

Further, the housing portion further comprises two limiting grooves communicating with the containing groove; the electrical contacting area compresses the conductive arm to bend and deform, and in a state where the conductive arm abuts against an inner wall of the limiting groove, the conductive arm drives the electrical contacting area to move in a direction away from the open end.

Further, the second mounting surface is planar and has multiple grooves, the positioning members are protruded at bottoms of the grooves; the first connecting end is attached to the second mounting surface, and the multiple positioning holes are spaced apart and correspond to the bottoms of the multiple grooves.

According to the second aspect of the embodiment of the disclosure, a charging device is provided, which comprising: a bearing structure comprising a housing portion and two mounting blocks fixedly connected to the housing portion, the housing portion having a containing groove, the two mounting blocks being oppositely arranged; and a power supply component comprising a connecting portion and two electrical contacting areas, the two electrical contacting areas being exposed on an inner side of the containing groove, the connecting portion comprising two contacting plates, the two contacting plates being electrically connected to the two electrical contacting areas respectively, and the two contacting plates being disposed on opposite sides of the two mounting blocks and spaced apart.

Further, the housing portion further comprises: a first housing having the containing groove, the containing groove being provided with two windows; and two second housings integrally formed with the first housing and located on a side of the first housing away from the open end, the second housings and the first housing forming limiting grooves and positioning concavity, the two limiting grooves communicating with the containing groove via the two windows respectively; wherein the two mounting blocks are projected on the first housing, the two mounting blocks are staggered with the two second housings in a cross-sectional direction of a depth of the containing groove.

Further, the first housing comprises a first side wall and a first end wall opposite to the open end, the first side wall surrounds the first end wall to form the containing groove, an end of the first side wall close to the first end wall is provided with the windows; the second housing comprises a second side wall and a second end wall, a thickness direction of the second end wall is consistent with a depth direction of the containing groove, the second side wall extends from the second end wall along the depth direction of the containing groove to a side of the first end wall away from the open end, the second side wall comprises a first part and a second part in an extending direction, the first part forms the limiting groove with the second end wall and the first end wall, an inner wall of the second part is a long waist hole, the second part is located on the side of the first end wall away from the open end, and the second part forms the positioning concavity with a portion of the first end wall.

Further, the two second housings correspond to the two mounting blocks respectively; in the cross-sectional direction of the depth of the containing groove, two extending sections extend along an outer side surface of the first housing in opposite directions.

Further, each extending section comprises a first segment and a second segment, the first segments of the two extending sections are attached to the outer side surface of the first housing and extending in opposite directions, the second segment is attached to an outer side surface of the second side wall and extends along the depth direction of the containing groove, one end of the second segment extends to an edge of the second side wall away from the second end wall and is connected to the second connecting end, and another end of the second segment is connected to one end of the first segment, another end of the first segment extends to a bottom of the mounting block and is connected to the first connecting end.

Further, the charging device comprises two bearing structures, and the power supply component further comprises a feeding portion; the feeding portion comprises feeding spring sheets and a circuit board, the circuit board comprises four feeding areas, the feeding spring sheets form two pairs of feeding spring sheets, the two pairs of feeding spring sheets correspond to the two bearing structures respectively, and the two pairs of feeding spring sheets are disposed on the four feeding arcas.

According to the third aspect of the embodiment of the disclosure, a charging device is provided, which comprising: a housing portion having a containing groove, the containing groove having an open end; and a conductive arm comprising a first deformation section, a second deformation section, and an electrical contacting segment in an extending direction, the first deformation section being connected between the second deformation section and the electrical contacting segment, an end of the electrical contacting segment having an electrical contacting area; wherein, in a free state of the conductive arm, the electrical contacting area is located in the containing groove, and an end of the electrical contacting segment provided with the electrical contacting area is inclined toward a bottom of the containing groove; the electrical contacting segment drives the conductive arm to elastically deform, the second deformation section bends and deforms to drive the electrical contacting segment to move in a direction away from the containing groove, and a portion of the first deformation section stretches and deforms to drive the electrical contacting area to move toward the open end.

Further, the housing portion further has a limiting groove, the limiting groove communicates with the containing groove, an inner wall of the limiting groove comprises a limiting surface; the second deformation section is disposed in the limiting groove, the electrical contacting segment extends from the limiting groove into the containing groove; the conductive arm bends and deforms and abuts against the limiting surface, and the electrical contacting area moves from the containing groove toward the limiting groove.

Further, the limiting surface comprises a first limiting surface, the first limiting surface is located on a side of the limiting groove close to the containing groove and extends along a depth direction of the containing groove; the second deformation section comprises a first curved segment, the first curved segment is curved toward the first limiting surface, and the second deformation section is located on a side of the first deformation section away from the open end.

Further, the first deformation section comprises a second curved segment, in the extending direction of the conductive arm, the second curved segment is located between the first curved segment and the electrical contacting segment, the second curved segment is curved in a direction away from the containing groove.

Further, the limiting surface further comprises a second limiting surface, the second limiting surface is spaced apart from the first limiting surface and faces the containing groove; the first deformation section further comprises a third curved segment, in the extending direction of the conductive arm, the third curved segment is located between the electrical contacting segment and the second curved segment, the electrical contacting segment extends from the third curved segment to the containing groove; the second curved segment stretches and deforms until the third curved segment abuts against the second limiting surface, and the first curved segment is in an abutting state with the first limiting surface.

Further, the limiting surface further comprises a third limiting surface, the third limiting surface is opposite to a direction of the open end and located on a side of the limiting groove close to the open end, the third curved segment is curved toward the third limiting surface.

Further, the second limiting surface extends along the depth direction of the containing groove, and a portion of the second limiting surface is opposite to the first limiting surface; the second deformation section further comprises a first connecting segment, the first connecting segment is connected between the first curved segment and the second curved segment; the first curved segment and the second curved segment are in an abutting state with the limiting surface, the first connecting segment is located between the first limiting surface and the second limiting surface; wherein the charging device further comprises a positioning portion; the second deformation section further comprises a second connecting segment, a third connecting segment, and a fourth curved segment connected between the second connecting segment and the third connecting segment, the first curved segment is connected between the first connecting segment and the second connecting segment, the third connecting segment extends from the fourth curved segment to the positioning portion, and the conductive arm is disposed on the housing portion via the positioning portion.

Further, the first deformation section further comprises a fifth connecting segment, the third curved segment is connected between the electrical contacting segment and the fifth connecting segment, and the fifth connecting segment is connected between the third curved segment and the second curved segment.

Further, the conductive arm is a strip-shaped structure, a bending direction of the conductive arm is perpendicular to a width direction of the strip-shaped structure, and widths of the first curved segment, the second curved segment, and the third curved segment decreases sequentially.

Further, the electrical contacting area is located at an end of the electrical contacting segment away from the third curved segment, and the electrical contacting area is an arc surface; the first deformation section further comprises a free segment, the free segment is disposed at an end of the electrical contacting segment away from the third curved segment and is curved in a direction away from the electrical contacting area; the electrical contacting area is curved in a direction away from the second limiting surface.

Further, the conductive arm further comprises a fixing section and a feeding end, the second deformation section is located between the first deformation section and the fixing section in the extending direction of the conductive arm, and the feeding end is located at an end of the fixing section away from the second deformation section.

Further, the fixing section comprises: two fifth curved segments and a fourth connecting segment connected between the two fifth curved segments, bending directions of the two fifth curved segments being opposite, the feeding end being disposed at an end of one of the fifth curved segments, and the second deformation section extending from the other fifth curved segment to the limiting groove.

Further, the containing groove has two windows, two limiting grooves communicate with the containing groove via the two windows respectively; two conductive arms extend into the containing groove via the two windows respectively, and width directions of the two conductive arms are perpendicular.

### BRIEF DESCRIPTION OF THE DRAWINGS

The above and other objectives, features, and advantages of the present disclosure will become clearer through the following description of embodiments of the present disclosure with reference to the accompanying drawings:

FIG. 1 is a structural diagram of a charging station in related technology;

FIG. 2 is an exploded diagram of a charging station in related technology;

FIG. 3 is a structural diagram of one side of a charging device according to an embodiment of the present disclosure;

FIG. 4 is a structural diagram of another side of a charging device according to an embodiment of the present disclosure;

FIG. 5 is a sectional diagram of a charging device according to an embodiment of the present disclosure;

FIG. 6 is a partial diagram of a charging device according to an embodiment of the present disclosure;

FIG. 7 is a partial diagram of a housing portion according to an embodiment of the present disclosure;

FIG. 8 is a structural diagram of a conductive arm, a positioning portion and an adhesive according to an embodiment of the present disclosure;

FIG. 9 is a structural diagram of a conductive arm and a positioning portion according to an embodiment of the present disclosure;

FIG. 10 is a structural diagram of a conductive arm according to an embodiment of the present disclosure;

FIG. 11 is a structural diagram of an earphone according to an embodiment of the present disclosure;

FIG. 12 is a structural diagram of a conductive arm according to some embodiments of the present disclosure;

FIG. 13 is a structural diagram of a conductive arm according to other embodiments of the present disclosure;

FIG. 14 is a structural diagram of a conductive arm according to further other embodiments of the present disclosure;

FIG. 15 is a structural diagram of a conductive arm according to still other embodiments of the present disclosure;

FIG. 16 is a structural diagram of a bearing structure and a containing case according to some embodiments of the present disclosure;

FIG. 17 is a structural diagram of a bearing structure and a containing case according to other embodiments of the present disclosure;

FIG. 18 is an exploded diagram of a charging device according to an embodiment of the present disclosure;

FIG. 19 is a structural diagram of connecting portions and one side of a bearing structure according to an embodiment of the present disclosure;

FIG. 20 is a structural diagram of connecting portions and another side of a bearing structure according to an embodiment of the present disclosure;

FIG. 21 is a partial diagram of a first connecting end and a mounting block according to an embodiment of the present disclosure;

FIG. 22 is a schematic diagram of a positional relationship between contacting plates and feeding spring sheets according to some embodiments of the present disclosure;

FIG. 23 is a schematic diagram of a positional relationship between contacting plates and feeding spring sheets according to other embodiments of the present disclosure;

FIG. 24 is a sectional diagram of a bearing structure according to an embodiment of the present disclosure;

FIG. 25 is a schematic diagram of a positional relationship between bearing structures and a circuit board according to an embodiment of the present disclosure.

### DETAILED DESCRIPTION OF EMBODIMENTS OF THE DISCLOSURE

The following describes the present application based on embodiments, but the present application is not limited to these embodiments. In the following detailed description of the present application, specific details are described in detail. For those skilled in the art, the present application may be fully understood without the description of these detailed parts. To avoid confusion of the essence of the present application, the well-known methods, processes, procedures, components, and circuits have not been described in detail.

In addition, ordinary technical personnel in this field should understand that the accompanying drawings provided here are for illustrative purposes and may not necessarily be drawn to scale.

Unless explicitly required by the context, words such as “comprising” and “containing” in the entire application document should be interpreted as containing rather than exclusive or exhaustive; that is to say, it means “comprising but not limited to”.

In the description of this application, it should be understood that the terms “first”, “second”, etc. are only used for descriptive purposes and cannot be understood as indicating or implying relative importance. In addition, in the description of this application, unless otherwise specified, the meaning of “multiple” refers to two or more.

Unless otherwise specified and limited, the terms “installation”, “connection”, “coupling”, “fixation”, etc. should be broadly understood, for example, they may be fixed connections, detachable connections, or integrated. It may be a mechanical connection or an electrical connection. It may be directly connected or indirectly connected through an intermediate medium, and may be a connection within two components or an interaction relationship between two components, unless otherwise specified. For ordinary technical personnel in this field, the specific meanings of the above terms in this application may be understood according to the specific situation.

For case of explanation, spatial terms such as “inside”, “outside”, “lower”, “below”, “under”, “upper”, “above”, etc. are used here to describe the relationship between one element or feature illustrated in the figure and another element or feature. It will be understood that space related terms may imply different orientations of the device during use or operation, apart from those depicted in the diagram. For example, if the device in the figure is flipped, the component described as being “below” or “under” other components or features will then be positioned “above” that other component or feature. Therefore, the example term “below” may encompass both the directions above and below. The device may be oriented in other ways (rotated 90 degrees or in other orientations), and the spatial descriptors used here should be explained accordingly.

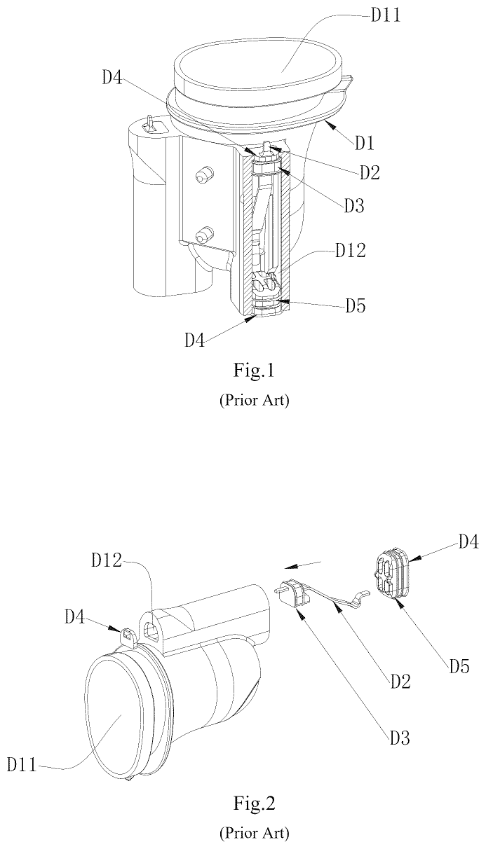

FIGS. 1 and 2 are diagrams of a charging station in related technology. The charging station in the figures includes a base body D1, a conductive spring sheet D2, a positioning body D3, a fixing member D4 and a blocking member D5. The base body D1 is provided with a receiving groove D11 for holding carphones and a mounting cavity D12 for setting conductive spring sheet D2. The mounting cavity D12 is provided with a first port and a second port, and the first port and the second port respectively face the upper and lower parts of the base body D1. During the installation of the charging station, it is necessary to fix the conductive spring sheet D2 and the positioning body D3 together, and then insert the conductive spring sheet D2 and the positioning body D3 into the mounting cavity D12 from the second port (as shown by the arrow in FIG. 2). Turn over the base body D1 so that the first port faces upward, and use the fixing member D4 to fixedly connect the conductive spring sheet D2 with the positioning body D3 and the first port. Finally, turn over the base body D1 again, block the second port with the blocking member D5, and fix it with the fixing member D4. When the conductive spring sheet D2 is installed, the end of the conductive spring sheet D2 far away from the positioning body D3 will be butted together with the base body D1 to avoid excessive bending of the conductive spring sheet D2 towards the receiving groove D11. The fixing member D4 is adhesive.

The conductive spring sheet D2 in this embodiment extends from the first port to the second port, which makes the occupied volume of the mounting cavity D12 too large and increases the volume of the base body D1. At the same time, in order to facilitate the setting of conductive spring sheet D2 in the mounting cavity D12, the first port and the second port are set on the mounting cavity D12. Therefore, the first port and the second port need to be blocked respectively.

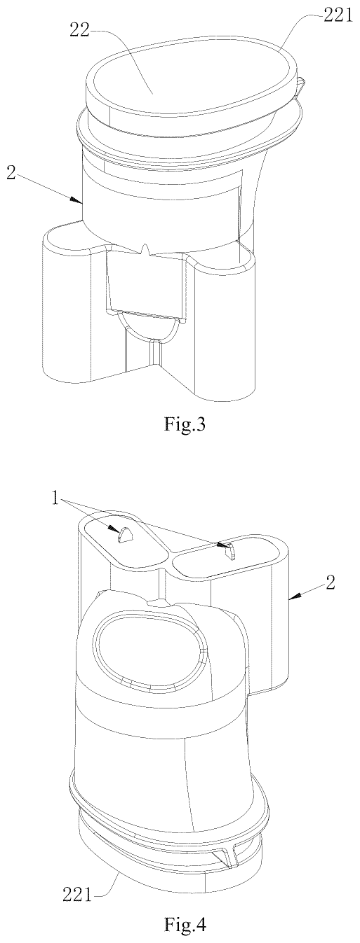

FIGS. 3 and 4 are structural diagrams of a charging device in this embodiment. FIG. 5 is a sectional diagram of a charging device in this embodiment.

In some embodiments, as shown in FIGS. 3 to 5, the charging device in this embodiment includes two conductive arms 1, and the conductive arms 1 are bent, and one end of each conductive arm 1 extends into the containing groove 22.

Specifically, the containing groove 22 in this embodiment is an carphone groove. The carphone groove is used to hold the earphones C (only one carphone is shown in the figures). When the carphones C are set in the containing groove 22, the contacts C1 of the earphones C may contact the conductive arms 1, and then charge the earphones C through the charging device. The earphones C may be Bluetooth earphones.

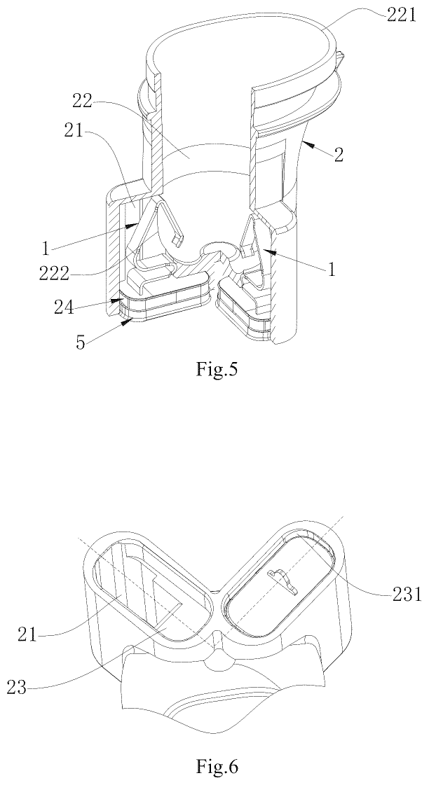

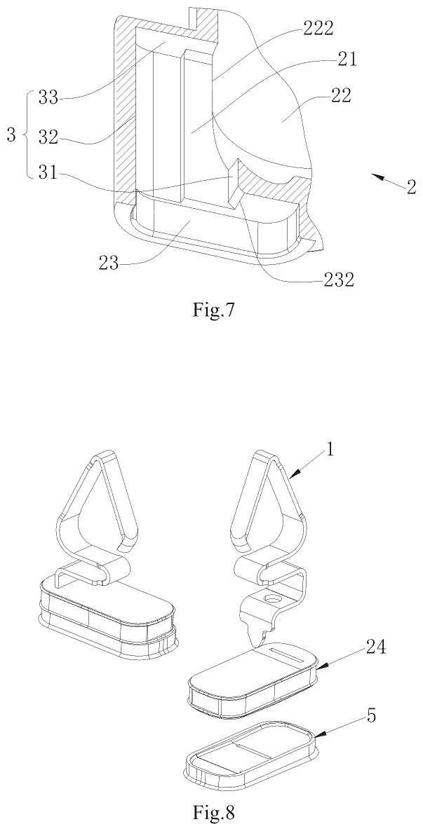

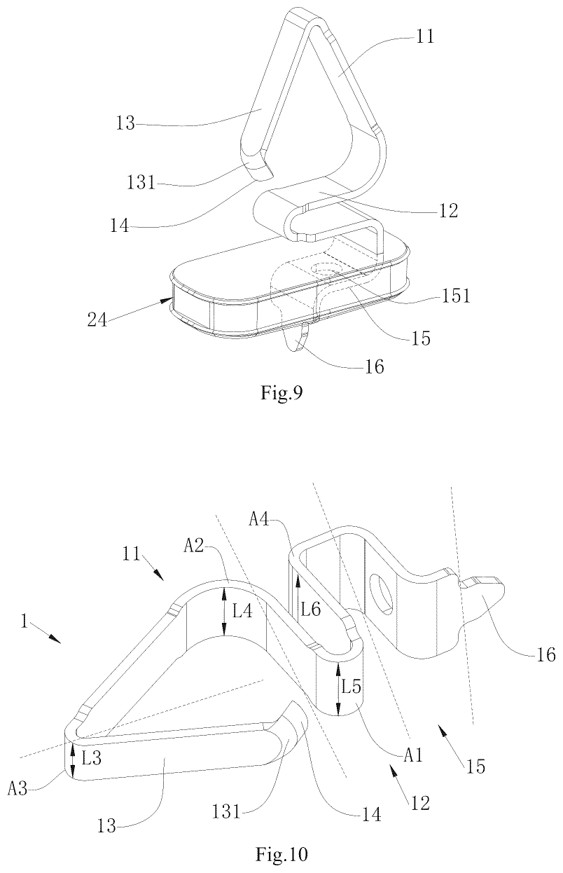

FIG. 6 is a partial diagram of a charging device according to an embodiment of the present disclosure. FIG. 7 is a partial diagram of a housing portion according to an embodiment of the present disclosure. FIG. 8 is a structural diagram of a conductive arm, a positioning portion and an adhesive according to an embodiment of the present disclosure. FIG. 9 is a structural diagram of a conductive arm and a positioning portion according to an embodiment of the present disclosure.

In some embodiments, as shown in FIGS. 6 to 9, the bearing structure 4 and the positioning portions 24 in this embodiment may be made by injection molding process. The material of the bearing structure 4 and the positioning portions 24 may be a polymer compound. For example, polyethylene, polyvinyl chloride, resin, or rubber. The rubber may be made of materials such as natural rubber (NR) or nitrile rubber (NBR). When the conductive arms 1 are arranged on the housing portion 2 through the positioning portions 24, the housing portion 2 and the positioning portions 24 may play a better insulation role.

FIG. 10 is a structural diagram of a conductive arm according to an embodiment of the present disclosure.

In some embodiments, as shown in FIG. 10, the material of the conductive arms 1 in this embodiment may be metal, such as copper, iron, copper alloy, aluminum alloy, etc. In the extending direction, each conductive arm 1 successively comprises a free segment 14, an electrical contacting segment 13, a first deformation section 11, a second deformation section 12, a fixing section 15 and a feeding end 16. The current may be transferred from the feeding end 16 to the contact C1 of an carphone C through the electrical contacting area 131.

FIG. 11 is a structural diagram of an carphone according to an embodiment of the present disclosure.

In some embodiments, as shown in FIG. 11, specifically, each earphone C in this embodiment includes an earphone stem C3 and an carphone head C2, and carphone head C2 is provided with a sound outlet. The earphone stem C3 is connected with the carphone head C2. Set the contact C1 on the earphone stem C3, so that when the earphone stem C3 is inserted into the containing groove 22, the contact C1 on the side of the earphone stem C3 butts against the conductive arm 1. A side surface of the carphone stem C3 is approximately cylindrical, and the bottom surface is approximately spherical crown.

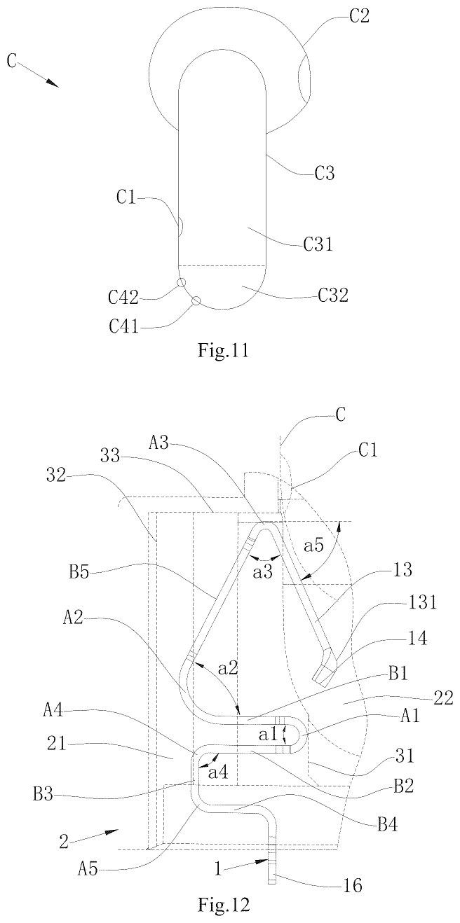

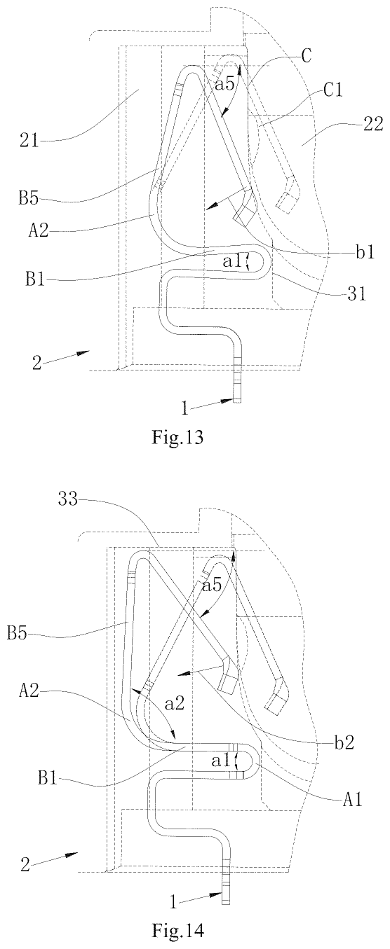

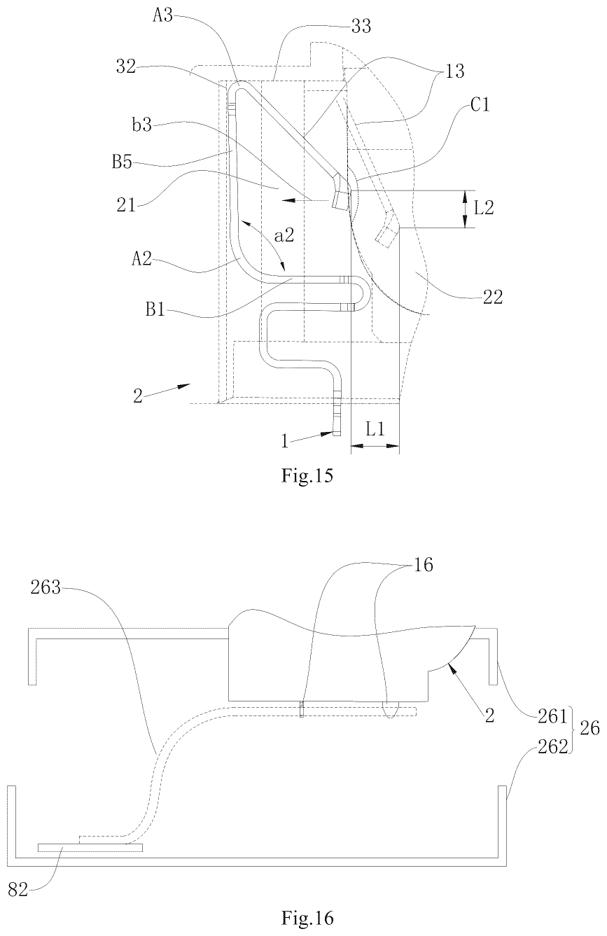

FIG. 12, FIG. 13, FIG. 14 and FIG. 15 are the structural diagrams of a conductive arm 1 in this embodiment under different deformation states. The figures show part of the outline of an carphone C, that is, the carphone stem C3 of an earphone C is set in a containing groove 22, and the contact C1 is set on the carphone stem C3. FIGS. 13 to 15 show the positions of the first deformation section 11 and the electrical contacting segment 13 in the free state with dotted lines.

Specifically, the carphone C in FIG. 12 is inserted into the containing groove 22, but the carphone C does not contact the conductive arm 1. In this form, the conductive arm 1 is in a free state, the electrical contacting segment 13 is located in the limiting groove 21 and the containing groove 22 at the same time, and the electrical contacting segment 13 is inclined to the containing groove 22. When the carphone stem C3 continues to move downward, the bottom of the carphone stem C3 will contact the electrical contacting segment 13. That is, the first position C41 and the electrical contacting segment 13. When the conductive arm 1 is in free state, the first curved segment A1, the second curved segment A2, the third curved segment A3, the fourth curved segment A4 and the fifth curved segment A5 are all in bending state.

As shown in FIGS. 12 to 15, an carphone C will go through the first stroke and the second stroke respectively when it enters the containing groove 22 from the open end 221 until it butts against the bottom of the containing groove 22.

In the first stroke (as shown in FIGS. 11 to 15), the bottom of the carphone stem C3 (that is, the first position C41, the second position C42, and the area between the first position C41 and the second position C42) contacts the electrical contacting segment 13, and the tilt amplitude of the electrical contacting segment 13 will increase (the angle a5 increases). At the same time, the electrical contacting segment 13 will move from the containing groove 22 to the limiting groove 21 along the radial direction of the containing groove 22, and move a distance away from the open end 221.

In the second stroke (as shown in FIG. 11 and FIGS. 14 to 15), as the carphone C continues to move towards the bottom of the containing groove 22, the end of the electrical contacting segment 13 will slip towards the peripheral surface C31 through the second position C42, and in this process, the tilt angle of the electrical contacting segment 13 will decrease (the angle a5 decreases).

When the angle a5 is decreased to a predetermined range, the carphone stem C3 will push the electrical contacting segment 13, so that the electrical contacting arca 131 is lifted towards the open end 221 until the electrical contacting area 131 is electrically in contact with the contact C1.

Optionally, as shown in FIG. 12, those skilled in the art may set the angle range between 50 degrees and 75 degrees. Under the pressure of the carphone stem C3, the end of the electrical contacting segment 13 will move a distance towards the bottom of the containing groove 22, so that the tilt amplitude of the electrical contacting area 131 may be increased to avoid the carphone C.

Specifically, FIG. 12 shows a specific configuration of the electrical contacting segment 13. When the electrical contacting segment 13 contacts the earphone C, it will first contact the first position C41. When the carphone C contacts the first position C41 (the conductive arm 1 does not deform), the angle a5 between electrical contacting segment 13 and horizontal direction is 66 degrees. Take the conductive arm 1 in free state, and the angle a5 is 66 degrees as an example. When the electrical contacting segment 13 slides to the second position C42, the angle a5 between the electrical contacting segment 13 and the horizontal direction becomes 72 degrees (the angle a1, the angle a2 and the angle a3 decrease). When the electrical contacting segment 13 continues to slide from the second position C42 to the peripheral surface C31, the angle a5 starts to decrease, that is, the tilt amplitude decreases. When the angle a5 is reduced to 53 degrees to 45 degrees, the electrical contacting segment 13 will move towards the open end 221 under the push of the carphone C.

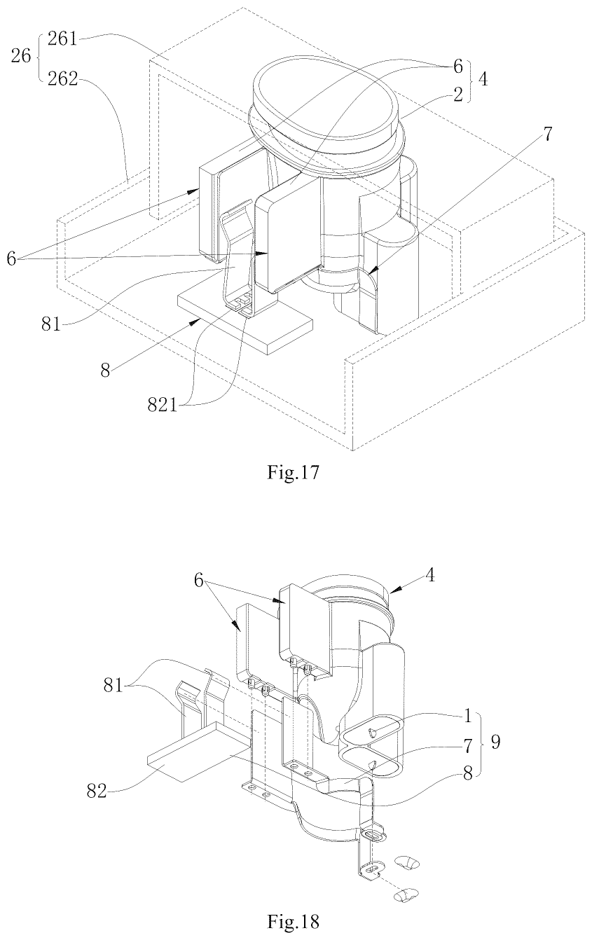

FIGS. 16 and 17 are the structural diagrams of a bearing structure 4 and a containing case 26 of the embodiment. The charging device in FIG. 16 also includes a flexible circuit board 263, a containing case 26, and a circuit board 82. The containing case 26 in the figure is in a split state. The containing case 26 includes a liner 261 and a basin base 262. The circuit board 82 is arranged at the basin base 262, and the bearing structure 4 is arranged at the liner 261. The circuit board 82 is used to supply power to the feeding end 16. The flexible circuit board 263 needs to meet certain length requirements so that the operator may connect one end of the flexible circuit board 263 with the feeding end 16 and the other end with the circuit board 82. Then, the liner 261 is installed on the basin base 262. In this form, the flexible circuit board 263 is curled in the containing case 26 to hold the flexible circuit board 263 through the containing case 26.

The charging device in FIG. 17 includes mounting blocks 6, connecting portions 7, a feeding portion 8, a containing case 26, and a circuit board 82. The containing case 26 in the figure is in the splicing state, and the partial outline of the containing case 26 is shown with dotted lines. The containing case 26 includes a liner 261 and a basin base 262. The feeding portion 8 is arranged at the basin base 262, and the bearing structure 4 is arranged at the liner 261.

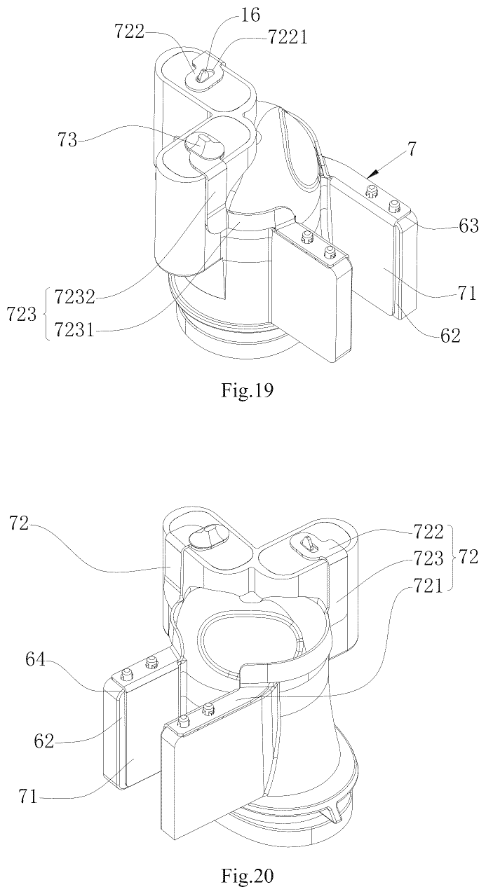

FIG. 18 is an exploded diagram of a charging device in this embodiment. FIGS. 19 and 20 are the structural diagrams of connecting portions 7 and a bearing structure 4 of this embodiment.

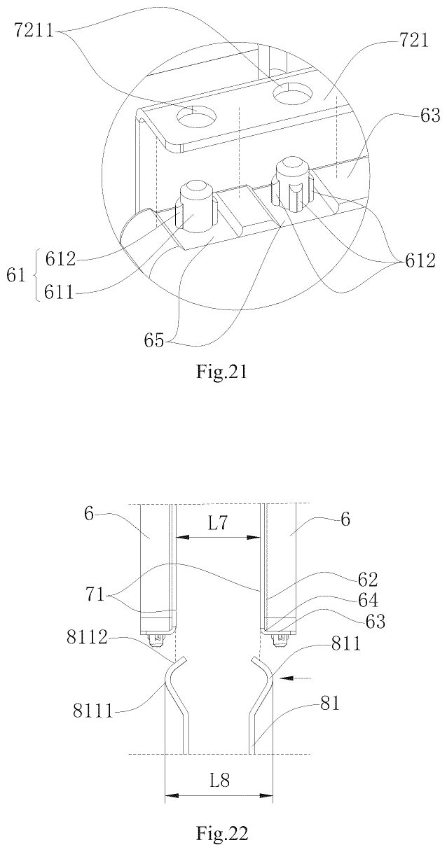

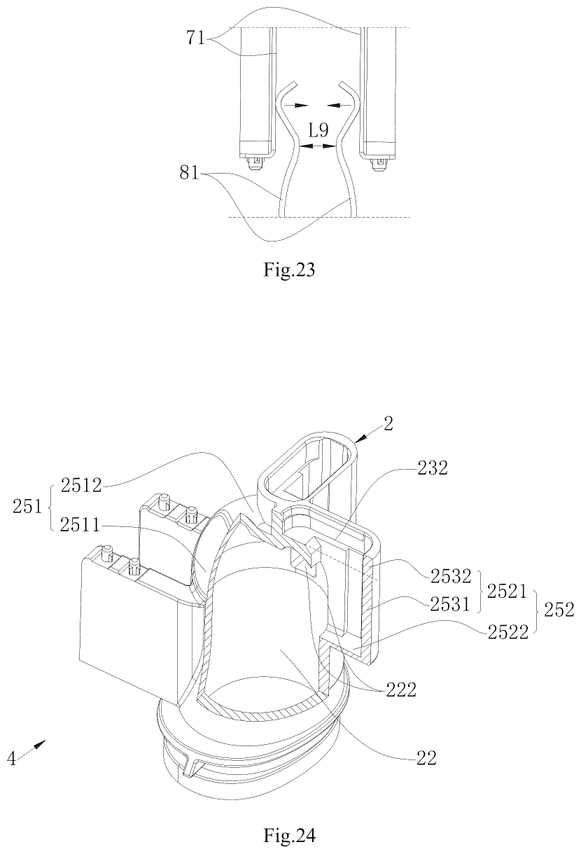

FIG. 21 is a partial diagram of a first connecting end 721 and a mounting block 6 of this embodiment. FIGS. 22 and 23 are schematic diagrams of a positional relationship between contacting plates 71 and feeding spring sheets 81 in this embodiment. FIG. 24 is a sectional diagram of a bearing structure 4 in this embodiment.

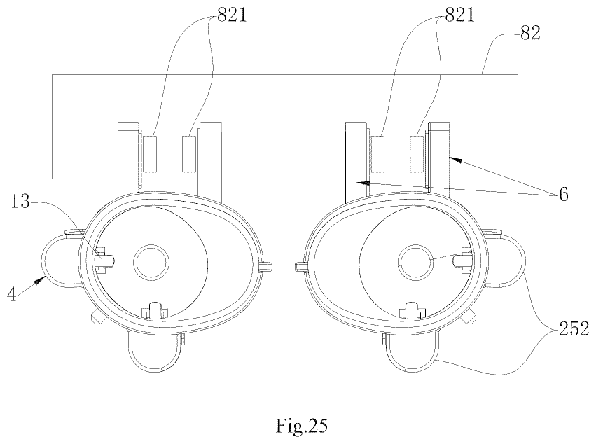

FIG. 25 is a schematic diagram of a positional relationship between bearing structures 4 and a circuit board 82 in this embodiment. The two bearing structures 4 in this embodiment are correspondingly set with the same circuit board 82.

In some embodiments, as shown in FIGS. 17 to 18, the charging device includes a bearing structure 4 and a power supply component 9. The power supply component 9 is used to charge the carphone C through the contact C1 when the carphone C is set on the bearing structure 4. The bearing structure 4 comprises a housing portion 2 and two mounting blocks 6 fixedly connected with the housing portion 2. Further referring to FIG. 5, the housing portion 2 is provided with a containing groove 22, and the two mounting blocks 6 are arranged relatively. There is a space between the two mounting blocks 6, so that contacting plates 71 may be set between the two mounting blocks 6.

Further referring to FIG. 9 and FIG. 18, the power supply component 9 includes a connecting portion 7 and two electrical contacting areas 131. The electrical contacting areas 131 are exposed to the inner side of the containing groove 22. The connecting portion 7 includes two contacting plates 71, two contacting plates 71 are electrically connected with two electrical contacting areas 131, and two contacting plates 71 are respectively arranged on the opposite sides of two mounting blocks 6 and are spaced.

Specifically, the two contacting plates 71 are positive plates and negative plates respectively. The charging device also includes two conductive arms 1 electrically connected with the connecting portion 7. The containing groove 22 has two windows 222. The two conductive arms 1 may be inserted into the containing groove 22 through the windows 222 at the positions where electrical contacting areas 131 are set, so that when the carphone C is set in the containing groove 22, it may be contacted with two contacts C1 of the positive and negative poles of the carphone C, so that power supply component 9 and the carphone C may be respectively through the connecting portion 7 and two electrical contacting areas 131 and two contacts C1 form a loop.

To sum up, the charging device in this embodiment sets the electrical contacting area 131 in the containing groove 22, so that when the carphone C is set in the containing groove 22, the electrical contacting areas 131 may be butted together with the contacts C1 to charge the carphone C. Therefore, two contacting plates 71 are respectively arranged on the opposite sides of two mounting blocks 6, and the electrical connecting positions of the electrical contacting areas 131 are led out to the outside of the containing groove 22 by the connecting portion 7. In order to facilitate the operator to install the charging device, two contacting plates 71 may be directly set at intervals to feed the current into two electrical contacting areas 131. Furthermore, the component of the charging device is simplified, and the cooperation of the bearing structure 4 and the power supply component 9 may adapt to different forms of installation structures. Moreover, the two contacting plates 71 are provided with a spacing, which may avoid the occurrence of short circuit when the feeding equipment is connected with the two electrical contacting areas 131.

In some embodiments, as shown in FIG. 17 and FIGS. 22 to 23, the power supply component 9 also includes a feeding portion 8, and the feeding portion 8 includes two feeding spring sheets 81 arranged in pairs. Two feeding spring sheets 81 are arranged between two contacting plates 71, two feeding spring sheets 81 are electrically overlapped with two contacting plates 71 respectively, and two feeding spring sheets 81 are bent towards the opposite side and set at intervals.

In this embodiment, the elastic deformations of two feeding spring sheets 81 are electrically connected with two contacting plates 71, saving the welding process. The connecting procedure between the feeding portion 8 and the connecting portion 7 is simpler.

In some embodiments, as shown in FIG. 17, the feeding portion 8 also includes a circuit board 82. The circuit board 82 includes a plurality of feeding areas 821, and the feeding spring sheets 81 are erected in the feeding areas 821. Further referring to FIGS. 22 to 23, each feeding spring sheet 81 includes a sixth curved segment 811, the sixth curved segment 811 has a abutting surface 8111, and two sixth curved segments 811 bend in a direction far from each other.

In the free states of the feeding spring sheets 81, the distance between the two abutting surfaces 8111 is greater than the distance between the two contacting plates 71. The two abutting surfaces 8111 are in contact with the two contacting plates 71 respectively, and the two feeding spring sheets 81 produce elastic bending.

In the free states of the feeding spring sheets 81, the distance between the two abutting surfaces 8111 (distance L8) is greater than the distance between the two contacting plates 71 (distance L7). When the two abutting surfaces 8111 are in contact with the two contacting plates 71, the two feeding spring sheets 81 are bent and deformed toward the opposite side (that is, close to each other). In this form, the distance between the two feeding spring sheets 81 is L9. In this embodiment, it is necessary to keep the distance L9 greater than 0 to avoid short circuit after the two feeding spring sheets 81 are bent.

Specifically, cach feeding spring sheet 81 has a fixing end, which is located at the end of the feeding spring sheet 81 far away from the sixth curved segment 811. The fixing end is bent and welded with the feeding area 821. So that the feeding spring sheet 81 may be stably arranged on the circuit board 82, and the feeding spring sheet 81 may be separated from the circuit board 82 when the feeding spring sheet 81 is bent.

In some embodiments, as shown in FIGS. 19 to 20, cach mounting block 6 has a first mounting surface 62, a second mounting surface 63, and an edge rib 64 located between the first mounting surface 62 and the second mounting surface 63. Two first mounting surfaces 62 are relatively arranged, the second mounting surface 63 faces the circuit board 82, and the edge rib 64 is arranged on the side of the first mounting surface 62 near the circuit board 82.

Further referring to FIG. 22 and FIG. 23, two contacting plates 71 are respectively arranged on two first mounting surfaces 62, and the edges of contacting plates 71 cover at least part of the corresponding edge ribs 64. The sixth curved segment 811 also includes a guiding inclined surface 8112, the guiding inclined surface 8112 is located on the side of the abutting surface 8111 that is far from the circuit board 82, and two guiding inclined surfaces 8112 are arranged obliquely towards the opposite side. In the free state of the feeding spring sheet 81, the spacing between the two guiding inclined surfaces 8112 is the same as that of the contacting plates 71 located on the two edge ribs 64.

The operator may insert the feeding spring sheets 81 from the lower part of the housing portion 2 to an area between the two contacting plates 71. In this process, the guiding inclined surface 8112 will contact the contacting plate 71 at the edge rib 64, making the two feeding spring sheets 81 bend in the direction close to each other, so as to ensure that the sixth curved segments 811 may slide into the two contacting plates 71.

In some embodiments, as shown in FIG. 20, the connecting portion 7 also includes two strip-shaped conductors 72, and each strip-shaped conductor 72 includes a first connecting end 721, a second connecting end 722, and an extending section 723 between the first connecting end 721 and the second connecting end 722. Two extending sections 723 are affixed to different areas on the outer side of the housing portion 2, two first connecting ends 721 are respectively connected to two contacting plates 71, and two second connecting ends 722 are respectively electrically connected to two electrical contacting areas 131.

It is easy to understand that after the liner 261 and the basin base 262 are installed together, the inner side of the containing case 26 will form a containing cavity. In this embodiment, two extending sections 723 are affixed on the outer side of the housing portion 2, which may reduce the occupation of the connecting portion 7 on the inner side of the containing cavity. At the same time, the two extending sections 723 are affixed to different areas on the outer side of the housing portion 2 to avoid short circuit between the two extending sections 723.

In some embodiments, as shown in FIG. 19 to FIG. 21, the bearing structure 4 also includes a plurality of positioning members 61, and a plurality of positioning members 61 are respectively projected on two mounting blocks 6. The first connecting end 721 is provided with a positioning hole 7211, and the positioning members 61 is clamped on the positioning hole 7211.

The positioning member 61 in this embodiment is used to fix the positioning hole 7211, so that the first connecting end 721 may be fixed together with the mounting block 6 to avoid the connecting portion 7 falling off from the bearing structure 4 during the installation and the use of the charging device.

In some embodiments, as shown in FIGS. 19 to 21, the positioning member 61 includes a column 611 and a plurality of flanges 612, and a plurality of flanges 612 are projected on the lateral side of the column 611.The column 611 extends into the positioning hole 7211, and a plurality of flanges 612 are butted with the hole edge of the positioning hole 7211.

Specifically, a plurality of flanges 612 are uniformly distributed around the column 611, the end of the column 611 is provided with a guide cone, and a plurality of flanges 612 are located at the bottom of the column 611. The side of the flange 612 close to the guide cone is provided with a guide bevel. When the positioning hole 7211 is sleeved on the positioning member 61, the guide cone may play a guiding role, and then the positioning hole 7211 will be sleeved on a plurality of flanges 612 through the guide bevel. At the same time, a plurality of flanges 612 are interference fit with the positioning hole 7211, so that the first connecting end 721 is stably connected with the mounting block 6, preventing the first connecting end 721 from falling off from the mounting block 6. The guide cone and the guide bevel provided in this embodiment help the operator to press the first connecting end 721 so that a plurality of flanges 612 may be clamped on the inside of the positioning hole 7211.

In some embodiments, as shown in FIG. 21, the mounting block 6 has a second mounting surface 63, the second mounting surface 63 is a plane and has a plurality of grooves 65, and the positioning member 61 is projected on the bottom of the groove 65. When the first connecting end 721 is affixed to the second mounting surface 63, a plurality of positioning holes 7211 are arranged in intervals and are opposite to the bottoms of a plurality of grooves 65.

The first connecting end 721 in this embodiment extends along the plane. When the first connecting end 721 fits with the second mounting surface 63, the connecting hole 7221 may keep a gap with the bottom of the positioning member 61 to avoid interference between the connecting hole 7221 and the connection position of the positioning member 61 and the groove 65.

In some embodiments, as shown in FIG. 5, the containing groove 22 has an open end 221. Further referring to FIGS. 19 to 20, the mounting block 6 also has a first mounting surface 62 and a second mounting surface 63, and the orientation of the second mounting surface 63 is opposite to that of the open end 221. The first connecting end 721 is set on the second mounting surface 63, part of the contacting plate 71 is set on the first mounting surface 62, and the edge of the contacting plate 71 extends to the first connecting end 721.

The first connecting end 721 in this embodiment is located at the bottom of the mounting block 6, and further referring to FIGS. 22 to 23, in the process of inserting the feeding spring sheet 81 from the contacting plate 71 far away from the open end 221 to the two contacting plates 71, a friction force is generated between the feeding spring sheet 81 and the contacting plate 71, and the friction force will face the direction of the open end 221. Thus, in this embodiment, the bottom of the mounting block 6 is set at the first connecting end 721. Through the cooperation between the first connecting end 721 and the second mounting surface 63, the friction force of the feeding spring sheet 81 acting on the contacting plate 71 may be offset, thus ensuring that after the liner 261 and the basin base 262 are installed, the connecting portion 7 and the feeding portion 8 may still be stably connected.

In some embodiments, as shown in FIGS. 8 to 9, the power supply component 9 also includes two conductive arms 1. Each conductive arm 1 includes an electrical contacting area 131, a fixing section 15 and a feeding end 16 in the extension direction. The fixing section 15 is located between the electrical contacting area 131 and the feeding end 16, and the fixing section 15 is fixedly connected with the bearing structure 4.

When the conductive arm 1 is in a free state, one end of the electrical contacting arca 131 set on the conductive arm 1 extends into the containing groove 22, the feeding end 16 and the second connecting end 722 are located on the side of the bearing structure 4 far away from the open end 221, and the second connecting end 722 is electrically connected with the feeding end 16.

Specifically, the material of the connecting portion 7 in this embodiment may be metal, such as copper, iron, copper alloy, aluminum alloy, and other materials. The connecting portion 7 may be made by stamping forming process. Therefore, the contacting plate 71 and the strip-shaped conductor 72 are integrally formed. In the process of connecting the connecting portion 7 with the bearing structure 4, the operator turns over the bearing structure 4 so that the open end 221 faces downward. Then move the connecting portion 7 from the upper direction of the bearing structure 4 to the bearing structure 4, so that the positioning hole 7211 is sleeved on the positioning member 61, the strip-shaped conductor 72 is pasted on the outer wall of the housing portion 2, and the connecting hole 7221 is sleeved on the feeding end 16. In this form, the feeding end 16 extends into the connecting hole 7221 and the feeding end 16 does not contact the connecting hole 7221, so as to avoid the stress between the connecting portion 7 and the bearing structure 4 and the conductive arm 1. Finally, the second connecting end 722 and the feeding end 16 are fixed together by soldering.

In some embodiments, as shown in FIGS. 6 to 9, the housing portion 2 also has a positioning concavity 23, and the positioning concavity 23 is opposite to the orientation of the containing groove 22. The charging device also includes a positioning portion 24, and the fixing section 15 is arranged on the positioning concavity 23 through the positioning portion 24.

Specifically, the conductive arm 1 in this embodiment also includes a first deformation section 11 and a second deformation section 12. The first deformation section 11 and the second deformation section 12 may deform when the earphone C is set in the containing groove 22. In this form, the fixing section 15 may be matched with the positioning portion 24 to ensure that it may be stably set on the bearing structure 4 during the deformation of the first deformation section 11 and the second deformation section 12.

Further, the positioning portion 24 is an injection-molded part. The fixing section 15 is arranged in the positioning portion 24, and the feeding end 16 extends from the positioning portion 24.

Specifically, the fixing section 15 includes the fourth connecting segment B4, the fourth connecting segment B4 is provided with a fixed through-hole 151, and the positioning portion 24 fills the fixed through-hole 151.In this embodiment, the conductive arm 1 and the positioning portion 24 adopt the insert molding process, and the positioning portion 24 and the fixing section 15 as the insert are molded together. The fixed through-hole 151 may make the fixing section 15 and the positioning portion 24 stably connected.

In some embodiments, as shown in FIGS. 5 to 9, the side of the positioning portion 24 close to the open end 221 is bonded with the bottom surface of the positioning concavity 23, the side far away from the open end 221 forms an adhesive groove 231 with the positioning concavity 23, and the feeding end extends from the inside of the adhesive groove 231 to the outside of the adhesive groove 231. The charging device also includes adhesive 5, and adhesive 5 fills adhesive groove 231. When the adhesive 5 is cured, the positioning portion 24 and the housing portion 2 may be fixed together.

In this embodiment, the positioning portion 24 and the positioning concavity 23 are mutually positioned, and the adhesive 5 is used to fix the tail of the positioning concavity 23, the positioning portion 24 and the feeding end 16 (that is, the area where the feeding end 16 is close to the positioning portion 24). Thus, the position accuracy is maintained in the deformation process of the conductive arm 1, especially in repeated use. Furthermore, the conductive arm 1 may be accurately matched with the first limiting surface 31, the second limiting surface 32 and the third limiting surface 33.

Further, the bottom of the positioning concavity 23 is provided with a connecting window 232. The limiting groove 21 extends far from the open end 221, and is connected with the positioning concavity 23 through the connecting window 232. The positioning portion 24 in this embodiment may be matched with the positioning concavity 23 to ensure the installation accuracy between the conductive arm 1 and the housing portion 2. At the same time, when the positioning portion 24 is installed in the positioning concavity 23, the conductive arm 1 may extend into the limiting groove 21 through the connecting window 232. Thus, the installation mode of the conductive arm 1 is simplified.

In some embodiments, as shown in FIGS. 19 to 20, the connecting portion 7 also includes a plurality of solder blocks 73. The top of the cured adhesive 5 is flush with the top of the adhesive groove 231. The second connecting end 722 is provided with a connecting hole 7221, the second connecting end 722 extends from the top edge of the adhesive groove 231 to the top of the adhesive 5, and the connecting hole 7221 is sleeved on the feeding end 16, the second connecting end 722 is fixedly connected with the adhesive 5 and the feeding end 16 through the solder block 73, and the second connecting end 722 is electrically connected with the feeding end 16.

The solder blocks 73 in this embodiment may fix the second connecting end 722 with the adhesive 5 and the feeding end 16 together, and may also play the role of electrically connecting the second connecting end 722 and the feeding end 16.

The charging device in the above embodiment may be installed according to the following steps: first, the conductive arm 1 is set on the positioning portion 24 by adopting the insert molding process. Then, turn the housing portion 2 so that the positioning concavity 23 faces upward, install the positioning portion 24 in the positioning concavity 23, and set the conductive arm 1 in the limiting groove 21 and the containing groove 22. Next, fill the adhesive groove 231 with adhesive 5, and keep the feeding portion 8 protruding from the adhesive 5. Finally, when the adhesive 5 is cured, the component may be completed.

Easy to understand, compared to the structure of the charging station shown in FIGS. 1-2, the charging device in this embodiment has fewer components, reducing manufacturing costs. At the same time, only adhesive 5 needs to be filled in the positioning concavity 23 once, which improves the yield. On the other hand, the bending setting of the conductive arm 1 in this embodiment reduces the space occupied by the conductive arm 1 and the volume of the limiting groove 21. On the other hand, when the conductive arm 1 is in a free state, the free segment 14 is in a suspended state. That is to say, the electrical contacting area 131 does not need to be positioned through the housing portion 2, thus further reducing the requirements for the installation accuracy of the conductive arm 1.

In some embodiments, as shown in FIG. 5, FIG. 6 and FIG. 15, the containing groove 22 has two windows 222, and two limiting grooves 21 are connected with the containing groove 22 through two windows 222 respectively. Two conductive arms 1 extend into the containing groove 22 through two windows 222 respectively, and the width directions of the two conductive arms 1 are vertical (the included angle of the two dotted lines in FIG. 25 is 90 degrees).

Specifically, the charging device in this embodiment feeds DC power to carphone C. Two conductive arms 1 are respectively used to connect two contacts C1 of earphones C. The two contacts C1 are positive and negative respectively. At the same time, the width directions of the two conductive arms 1 are vertical. When the two conductive arms 1 touch earphones C, it may ensure that the two conductive arms 1 stably touch the earphones C against the inner wall of the containing groove 22.

In some embodiments, as shown in FIG. 5 and FIGS. 17 to 19, there are two positioning portions 24, two positioning concavities 23, two limiting grooves 21 and two conductive arms 1, and the two conductive arms 1 are simultaneously set corresponding to the two limiting grooves 21, the two positioning concavities 23 and the two positioning portions 24.

Further, as shown in FIG. 18, the positioning member 61 is arranged at the bottom of the mounting block 6, and the column 611, the adhesive groove 231 and the feeding end 16 are all facing below the housing portion 2. The connecting portion 7 in this embodiment may be installed on the housing portion 2 from the lower part of the housing portion 2, so that the positioning hole 7211 and the connecting hole 7221 are simultaneously sleeved on the feeding end 16 and the positioning member 61. Thus, the component of charging device has been simplified.

In some embodiments, as shown in FIGS. 12 to 15, the housing portion 2 also has two limiting grooves 21 connected with the containing groove 22. The electrical contacting arca 131 compresses the conductive arm 1, which is bent and deformed, and the conductive arm 1 is in contact with the inner wall of the limiting groove 21. The conductive arm 1 drives the electrical contacting area 131 to move far away from the open end 221. The conductive arm 1 in this embodiment may cooperate with the limiting groove 21 to avoid earphone C.

In some embodiments, as shown in FIG. 20 and FIG. 24, the housing portion 2 also includes a first housing 251 and two second housings 252. The first housing 251 is provided with a containing groove 22, which is provided with two windows 222. The two second housings 252 are integrally formed with the first housing 251 and are located on the side of the first housing 251 far away from the open end 221. The second housing 252 and the first housing 251 form a limiting groove 21 and a positioning concavity 23, and two limiting grooves 21 are respectively connected with the containing groove 22 through two windows 222.

Further referring to FIG. 25, two mounting blocks 6 are projected on the first housing 251, and two mounting blocks 6 are staggered with two second housings 252 in the section direction of the depth of the containing groove 22.

Further, the two contacting plates 71 are parallel to each other, and the two contacting plates 71 are perpendicular to the circuit board 82. In this embodiment, two mounting blocks 6 are arranged on one side of the first housing 251, so that the feeding portion 8 may be arranged on one side of the housing section 2 and supply power to the conductive arm 1. As shown in FIG. 25, when the number of housing sections 2 is multiple, multiple mounting blocks 6 are arranged at positions corresponding to circuit board 82, which helps the feeding portion 8 to use one circuit board 82 to supply power to multiple groups of contacting plates 71.

In some embodiments, as shown in FIG. 24, the first housing 251 includes a first side wall 2511 and a first end wall 2512 opposite to the open end 221, the first side wall 2511 forms a containing groove 22 around the first end wall 2512, and the end of the first side wall 2511 near the first end wall 2512 is provided with a window 222.

The second housing 252 includes a second side wall 2521 and a second end wall 2522, and the thickness direction of the second end wall 2522 is consistent with the depth direction of the containing groove 22. The second side wall 2521 extends from the second end wall 2522 along the depth direction of the containing groove 22 to the side of the first end wall 2512 far away from the open end 221. The second side wall 2521 includes a first part 2531 and a second part 2532 in the extension direction, and the first part 2531 forms a limiting groove 21 with the second end wall 2522 and the first end wall 2512. The inner wall of the second part 2532 is a long waist hole, the second part 2532 is located on the side of the first end wall 2512 far away from the open end 221, and the second part 2532 forms a positioning concavity 23 with part of the first end wall 2512.

In this embodiment, the adhesive 5 is flush with the edge far away from the open end 221 of the second part 2532, so that the second connecting end 722 may be arranged at the bottom of the bearing structure 4. At the same time, the configuration of the first housing 251 and the second housing 252 may further reduce the weight of the charging device and save the internal space of the containing case 26.

In some embodiments, as shown in FIG. 24, two second housings 252 are respectively arranged with two mounting blocks 6. Further referring to FIG. 20, in the section direction of the depth of the containing groove 22, the two extending sections 723 extend along the outer side of the first housing 251 in opposite directions.

The connecting portion 7 in this embodiment may avoid the short circuit of two strip-shaped conductor 72, and at the same time, maximize the space on the outer side of the housing portion 2.

In some embodiments, as shown in FIG. 19, the extending section 723 includes the first segment 7231 and the second segment 7232. Two first segments 7231 of the two extending sections 723 are affixed to the outer surface of the first housing 251 and extend in opposite directions. The second segment 7232 is attached to the outer side of the second side wall 2521 and extends along the depth direction of the containing groove 22. One end of the second segment 7232 extends to the edge of the second side wall 2521 away from the second end wall 2522 and is connected with the second connecting end, the other end is connected with one end of the first segment 7231, and the other end of the first segment 7231 extends to the bottom of the mounting block 6 and is connected with the first connecting end 721.

The first segment 7231 and the second segment 7232 in this embodiment are vertically connected, so that the extending section 723 may adapt to the shape of the outer surface of the bearing structure 4 better. Furthermore, the structure of the extending section 723 is simplified for processing. At the same time, the length of the extending section 723 may be shortened as far as possible to reduce current loss.

In some embodiments, as shown in FIG. 25, there are two bearing structures 4. The circuit board 82 includes four feeding areas 821. Multiple feeding spring sheets 81 form two pairs of feeding spring sheets 81, two pairs of feeding spring sheets 81 are respectively set with two bearing structures 4, and two pairs of feeding spring sheets 81 are set in four feeding areas 821.

Specifically, the charging device in this embodiment includes a containing case 26, two constituent units, and a feeding portion 8. The two composition units are respectively used for setting two carphones C, and the two composition units are set on the liner 261. The composition unit includes the conductive arm 1, the housing portion 2, the positioning portion 24, the adhesive 5, the mounting block 6 and the connecting portion 7 in the above embodiment. The feeding portion 8 includes a circuit board 82 and four feeding spring sheets 81 arranged on the circuit board 82. When the operator installs the liner 261 and the basin base 262, the feeding spring sheet 81 and the contacting plate 71 may be directly lapped together, and the connection between the two composition units and the feeding portion 8 may be realized at the same time. This greatly simplifies the installation process of charging device, avoids the occupation of the internal space of the containing case 26 by the flexible circuit board 263.

In some embodiments, as shown in FIGS. 3 to 5, the charging device in this embodiment includes a conductive arm 1 and a housing portion 2. The housing portion 2 is provided with a containing groove 22, which is provided with an open end 221. The carphone stem C3 may be put into the containing groove 22 from the open end 221.

Further referring to FIGS. 9 to 10, the conductive arm 1 includes the first deformation section 11, the second deformation section 12 and the electrical contacting segment 13 in the extension direction. The first deformation section 11 is connected between the second deformation section 12 and the electrical contacting segment 13, that is, two ends of the first deformation section 11 are respectively connected with the second deformation section 12 and the electrical contacting segment 13. Meanwhile, the end of the electrical contacting segment 13 is provided with an electrical contacting area 131. When the carphone C is set in the containing groove 22, the electrical contacting area 131 is used to contact with the contact C1, thereby realizing the electrical connection between the two.

At the same time, when the conductive arm 1 is in a free state, that is, when the conductive arm 1 is not in contact with the carphone C, the electrical contacting area 131 is located in the containing groove 22, and one end of the electrical contacting area 131 set in the electrical contacting segment 13 is inclined to the bottom of the containing groove 22.

Further referring to FIGS. 13 to 14, the conductive arm 1 is configured so that during the process of driving the elastic deformation of the conductive arm 1 by the electrical contacting segment 13, the second deformation section 12 bends and deforms to drive the electrical contacting segment 13 to move away from the containing groove 22.

Specifically, in this embodiment, the bottom of the carphone C exerts a thrust on the electrical contacting area 131, driving the electrical contacting segment 13 to generate displacement. Among them, the second deformation section 12 produces elastic bending deformation, which shortens the size of the second deformation section 12 in the height direction of the charging device, so that the second deformation section 12 may drive the first deformation section 11 to move towards the bottom of the charging device, and the electrical contacting segment 13 may avoid the carphone C.

Optionally, driven by the carphone C, part of the first deformation section 11 also produces elastic bending deformation, so that the first deformation section 11 may cooperate with the second deformation section 12 to produce deformation, thus increasing the deformation amplitude of the conductive arm 1.

In the above process, the end of the electrical contacting segment 13 will gradually slide from the bottom surface of the carphone stem C3 to the side surface (as shown in FIGS. 13 to 14). In this form, when the tilt angle of the electrical contacting segment 13 is reduced to a predetermined range (for example, 53 degrees to 45 degrees), part of the first deformation section 11 will stretch and deform, that is, the bending amplitude of part of the first deformation section 11 will reduce, thus driving the electrical contacting area 131 to move towards the open end 221, and finally contact with the contact C1.

Specifically, the electrical contacting segment 13 in this embodiment moves from the bottom of the carphone stem C3 to the side of the carphone stem C3 (as shown by the distance L1 in FIG. 15), so that the electrical contacting segment 13 is located at the side of the carphone stem C3. In this form, the second deformation section 12 may be extended to raise the position of the electrical contacting area 131 (as shown in the distance L2 in FIG. 16), so that the electrical contacting arca 131 is butted with the contact C1.

To sum up, the charging device in this embodiment is provided with electrical contacting segment 13, first deformation section 11 and second deformation section 12 on the conductive arm 1, and electrical contacting area 131 is arranged at the end of electrical contacting segment 13. Therefore, on the one hand, the second deformation section 12 may drive the electrical contacting segment 13 away from the containing groove 22, so that carphone C may avoid the space in the containing groove 22.

On the other hand, when the conductive arm 1 is not compressed, the electrical contacting area 131 is located on the inner side of the containing groove 22, and makes the conductive arm 1 tilt to the bottom of the containing groove 22. It is helpful to transform the downforce generated by carphone C into the driving force acting on electrical contacting segment 13. At the same time, when the tilt amplitude of the first deformation section 11 at the electrical contacting segment 13 is reduced to a predetermined range, under the continuous push of the carphone C, part of the first deformation section 11 is stretched and deformed, so as to drive the electrical contacting area 131 to move towards the open end 221, thereby raising the position of the electrical contacting arca 131, so that the electrical contacting area 131 may be butted with the contact C1.

On the other hand, the first deformation section 11 and the second deformation section 12 produce stretching deformation and bending deformation respectively. On the premise of increasing the deformation amplitude of the conductive arm 1, the elastic force exerted by the conductive arm 1 on the carphone C is limited, and the service life of the conductive arm 1 is improved.

Optionally, the charging device in this embodiment includes a first magnetic body. The earphone C comprises a second magnetic body. When the earphone C is set in the containing groove 22, the first magnetic body and the second magnetic body attract each other, so that the earphone C may be stably set on the charging device.

Further referring to FIG. 15, when the electrical contacting segment 13 in this embodiment is butted with the contact C1, the position of the electrical contacting area 131 is raised, while the tilt amplitude of the electrical contacting segment 13 is reduced, which may avoid the electrical contacting segment 13 with tilt setting and lift the earphone C from the bottom of the earphone stem C3.

In some embodiments, as shown in FIGS. 5 to 7, the housing portion 2 is also provided with a limiting groove 21, the limiting groove 21 is connected with the containing groove 22, and the inner wall of the limiting groove 21 includes a limiting surface 3.

Further referring to FIGS. 9 to 12, the second deformation section 12 is set at the limiting groove 21, and the electrical contacting segment 13 extends from the limiting groove 21 to the containing groove 22. When the conductive arm 1 is bent and deformed and touches the limiting surface 3, the electrical contacting area 131 moves from the containing groove 22 to the limiting groove 21.

In this embodiment, when the conductive arm 1 is bent and deformed, some areas of the conductive arm 1 will contact with the limiting groove 21, thereby limiting the deformation state of the conductive arm 1 and ensuring the elastic force generated by the conductive arm 1. Meanwhile, when the electrical contacting segment 13 is far away from the containing groove 22, the limiting groove 21 may be used to hold the electrical contacting segment 13.

In some embodiments, as shown in FIGS. 12 to 13, the limiting surface 3 includes a first limiting surface 31. The first limiting surface 31 is located at the side of the limiting groove 21 close to the containing groove 22 and extends along the depth direction of the containing groove 22. The second deformation section 12 includes a first curved segment A1, the first curved segment A1 bends towards the first limiting surface 31, and the second deformation section 12 is located at the side of the first deformation section 11 far away from the open end 221.

Specifically, the first curved segment A1 is in a bending state in a free state, and its bending amplitude is angle a1. The angle a1 may be 180 degrees.

Further referring to FIG. 13, in the process of carphone C pressing against the electrical contacting segment 13, the electrical contacting segment 13 transmits the downforce through the first deformation section 11 to the first curved segment A1, causing the first curved segment A1 to bend and deform (the angle a1 decreases). In this form, the first curved segment A1 is in contact with the first limiting surface 31, and the first curved segment A1 drives the first deformation section 11 to tilt away from the containing groove 22. In this process, the electrical contacting area 131 moves along the horizontal direction of the containing groove 22, and the tilt amplitude of the electrical contacting segment 13 decreases (the angle a5 decreases).

The first curved segment A1 in this embodiment may tilt the first deformation section 11 as a whole, so as to facilitate the adjustment of the angle of the electrical contacting segment 13, and enable the first deformation section 11 to enter into the limiting groove 21 more, helping the first deformation section 11 to stretch and deform under the push of the carphone C.

In some embodiments, as shown in FIGS. 12 to 15, the first deformation section 11 includes a second curved segment A2. In the length direction of the conductive arm 1, the second curved segment A2 is located between the first curved segment A1 and the electrical contacting segment 13, and the second curved segment A2 bends away from the containing groove 22.

In the process of bending deformation of first curved segment A1 and driving second curved segment A2 to incline away from the containing groove 22, the second curved segment A2 extends and deforms (the angle a2 increases) to drive the electrical contacting segment 13 close to the open end 221.

In the process of extension and deformation of the second curved segment A2 in this embodiment, carphone C continuously applies thrust to the electrical contacting segment 13, and the direction of the thrust applied by carphone C to the electrical contacting segment 13 gradually changes from inclined downward to horizontal. That is to say, as shown in FIGS. 13 to 15, the direction of applying thrust changes as indicated by arrows b1, b2, and b3.

It is easy to understand that, as shown by arrows b2 and b3, the thrust exerted by carphone C may be transmitted to fifth connecting segment B5 through the electrical contacting segment 13. In this form, carphone C may drive the fifth connecting segment B5 to open with the first connecting segment B1, so that second curved segment A2 will have extension deformation.

In some embodiments, as shown in FIGS. 7, 11 and 14, the limiting surface 3 also includes the second limiting surface 32. The second limiting surface 32 and the first limiting surface 31 are set at intervals and face the containing groove 22. That is, the second limiting surface 32 is located at the side of the limiting groove 21 away from the containing groove 22.

The first deformation section 11 also includes a third curved segment A3. In the length direction of the conductive arm 1, the third curved segment A3 is located between the electrical contacting segment 13 and the second curved segment A2, and the electrical contacting segment 13 extends from the third curved segment A3 to the containing groove 22. The second curved segment A2 extends and deforms until the third curved segment A3 butts against the second limiting surface 32, and the first curved segment A1 butts against the first limiting surface 31.

Specifically, when the carphone C is set in the containing groove 22, the earphone stem C3 will push the third curved segment A3 against the second limiting surface 32, and the second limiting surface 32 will make the first deformation section 11 unable to continue moving. In contrast, the first curved segment A1 butts against the first stop surface 31. In this form, the shape of the first deformation section 11 and the second deformation section 12 in the horizontal direction is limited by the limiting groove 21, so that the conductive arm 1 may apply enough elastic force to contact C1 through the limiting groove 21, thus maintaining the stable connection between electrical contacting area 131 and contact C1.

In some embodiments, as shown in FIG. 12, the limiting surface 3 also includes a third limiting surface 33. The third limiting surface 33 is opposite to the open end 221, and is located at the side of the limiting groove 21 near the open end 221. The third curved segment A3 bends to the third limiting surface 33.

Further referring to FIGS. 14 to 15, when the tilt amplitude of the electrical contacting segment 13 is within a predetermined range, the first curved segment A1 and the second curved segment A2 stretch and deform, so as to drive the third curved segment A3 to contact the third limiting surface 33 and slip towards the second limiting surface 32.

Specifically, the third limiting surface 33 in this embodiment is vertically connected with the second limiting surface 32. When carphone C is in the first stroke, first curved segment A1 is in bending deformation. When carphone C is in the second stroke, first curved segment A1 is stretched deformation, that is, from the state shown in FIG. 13 to the state shown in FIG. 14. In this form, first curved segment A1 in FIG. 14 is still in bending shape, but the bending amplitude is reduced compared with FIG. 13. Thus, the first curved segment A1 drives the first deformation section 11 close to the third limit surface 33, so that the third curved segment A3 is butted with the third limit surface 33. Driven by the extension deformation of the second curved segment A2, the third curved segment A3 will slide towards the second limiting surface 32 until it touches the second limiting surface 32.

Therefore, the third limiting surface 33 in this embodiment may limit the lifting height of the electrical contacting segment 13, so as to avoid excessive lifting of the electrical contacting area 131. At the same time, in the first stroke and the second stroke, the bending amplitude of the first curved segment A1 in the embodiment increases first and then decreases, so that the first curved segment A1 may buffer the fall of carphone C, and reduce the speed of earphone C when it contacts with the containing groove 22.

In some embodiments, as shown in FIGS. 12 and 15, the second limiting surface 32 extends along the depth direction of the containing groove 22, and part of the second limiting surface 32 is opposite to the first limiting surface 31. The second deformation section 12 also includes the first connecting segment B1, and the first connecting segment B1 is connected between the first curved segment A1 and the second curved segment A2.

When the first curved segment A1 and second curved segment A2 are in contact with the limiting surface 3, the first connecting segment B1 is located between the first limiting surface 31 and the second limiting surface 32. Therefore, the elastic force generated by the conductive arm 1 is transmitted to the first limiting surface 31 and the second limiting surface 32 respectively through the first connecting segment B1, thus limiting the deformation amplitude of the conductive arm 1 and ensuring that the electrical contacting area 131 is stably grounded with the contact C1. At the same time, the first curved segment A1 may also drive the first deformation section 11 to tilt through the first connecting segment B1 during bending deformation.

In some embodiments, as shown in FIGS. 8 to 9, the charging device also includes a positioning portion 24. Further referring to FIG. 12, the second deformation section 12 also includes the second connecting segment B2, the third connecting segment B3 and the fourth curved segment A4 connected between the second connecting segment B2 and the third connecting segment B3, and the first curved segment A1 connected between the first connecting segment B1 and the second connecting segment B2.

The third connecting segment B3 extends from the fourth curved segment A4 to the positioning portion 24, and the conductive arm 1 is arranged on the housing portion 2 through the positioning portion 24.

Specifically, when the conductive arm 1 is in the state, the first connecting segment B1 and the second connecting segment B2 extend radially along the containing groove 22, and the third connecting segment B3 extends along the depth direction of the containing groove 22 (the angle a4 is 90 degrees). The second connecting segment B2 and the first connecting segment B1 in this embodiment may increase the moment when the first curved segment A1 deforms, so that the first curved segment A1 is easier to deform. At the same time, the second connecting segment B2 and the third connecting segment B3 may also deform the fourth curved segment A4 to drive the first deformation section 11 close to or far away from the open end 221.

In some embodiments, as shown in FIGS. 12 to 15, the first deformation section 11 also includes the fifth connecting segment B5, and the third curved segment A3 is connected between the electrical contacting segment 13 and the fifth connecting segment B5. And the fifth connecting segment B5 is connected between the third curved segment A3 and the second curved segment A2.

The second curved segment A2 drives the electrical contacting segment 13 to move through the fifth connecting segment B5, and the third curved segment A3 bends and deforms, driving the electrical contacting segment 13 close to the fifth connecting segment B5. The third curved segment A3 in this embodiment may also bend and deform, thus increasing the overall bending amplitude of the conductive arm 1.

In some embodiments, as shown in FIGS. 10 to 12, the conductive arm 1 is a ribbon structure. The bending direction of the conductive arm 1 is perpendicular to the width direction of the ribbon structure, and the widths of the first curved segment A1, the second curved segment A2 and the third curved segment A3 decrease in turn. That is to say, the distance L3, distance L4, and distance L5 increase in sequence. The width of the fourth curved segment A4 may also be configured as the maximum, that is, the distance L6 is greater than distance L5.

In this embodiment, under the premise that the bending amplitude of each bending segment is the same, the larger the width of the bending segment, the greater the stress driving the bending of the bending segment. That is to say, the wider the curved section, the greater the elastic force generated.

The widths of first curved segment A1, second curved segment A2 and third curved segment A3 are configured to decrease in turn. When the electrical contacting segment 13 drives the conductive arm 1 to deform, the first deformation section 11 may deform rapidly, so that the electrical contacting segment 13 may be accommodated into the limiting groove 21. At the same time, after the first curved segment A1 changes the direction of the driving force of earphone C, the first curved segment A1 may restore its shape in time to deploy the second curved segment A2 with the thrust of earphone C.

Further, the width of the fifth connecting segment B5 is configured to be larger than that of the fourth connecting segment B4. Thus, the area connecting the conductive arm 1 and the positioning portion 24 is more rigid, and the position accuracy of the first deformation section 11 when moving is guaranteed.

Optionally, the first connecting segment B1, the second connecting segment B2, the electrical contacting segment 13 and the fifth connecting segment B5 extend along a straight line, and the lengths of the first connecting segment B1 and the second connecting segment B2 are greater than the lengths of the electrical contacting segment 13 and the fifth connecting segment B5. Therefore, the moment generated by the electrical contacting segment 13 and the fifth connecting segment B5 when they are close to or far from the third curved segment A3 is greater than the moment generated by the first connecting segment B1 and the second connecting segment B2 to the first curved segment A1. Therefore, the first deformation section 11 and the electrical contacting segment 13 are more likely to deform.

In some embodiments, as shown in FIGS. 11, 12 and 15, the electrical contacting area 131 is located at the end of the electrical contacting segment 13 far from the third curved segment A3, and the electrical contacting area 131 is an arc surface.

The first deformation section 11 also includes a free segment 14, and the free segment 14 is arranged at the end of the electrical contacting segment 13 away from the third curved segment A3 and bent in the direction away from the electrical contacting area 131. The conductive arm 1 is in a free state, and the electrical contacting area 131 bends away from the second limiting surface 32.

When one end of the electrical contacting area 131 set at the electrical contacting segment 13 is lifted towards the open end 221, the electrical contacting area 131 set at the bend may face the contact C1, so as to facilitate the electrical connection between the two. At the same time, the free segment 14 extends away from the earphone C and sets the electrical contacting area 131 as an arc surface. During the contact between the electrical contacting area 131 and the contact C1, the contact C1 and the carphone stem C3 may be avoided from being scratched.

In some embodiments, as shown in FIG. 9, the conductive arm 1 also includes a fixing section 15 and a feeding end 16. In the extension direction of the conductive arm 1, the second deformation section 12 is located between the first deformation section 11 and the fixing section 15, and the feeding end 16 is located at the end of the fixing section 15 away from the second deformation section 12. The charging device also includes a positioning portion 24, the positioning portion 24 is an injection molded part, the fixing section 15 is arranged in the positioning portion 24, and the feeding end 16 extends from the positioning portion 24. The feeding end 16 is used to feed current into the conductive arm 1.

In some embodiments, as shown in FIGS. 9 and 12, the fixing section 15 includes two fifth curved segments A5 and a fourth connecting segment B4 connected between two fifth curved segments A5. The bending directions of the two fifth curved segments A5 are opposite, the feeding end 16 is set at the end of a fifth curved segment A5, and the second deformation section 12 extends from the other fifth curved segment A5 to the limiting groove 21.

In this embodiment, the length of the fixing section 15 is increased by two fifth curved segments A5, thereby increasing the contact area between the conductive arm 1 and the positioning portion 24, so that they are connected stably. The position of feeding end 16 in the horizontal direction may also be adjusted.

In an optional implementation, the charging device in the above embodiment may be applied to the carphone component. The carphone component also includes an carphone C. The carphone C includes a contact C1. When the carphone C is set in the containing groove 22, the contact C1 contacts with the electrical contacting area 131.

To sum up, the carphone component in this embodiment sets the electrical contacting arca 131 in the containing groove 22, so that when the carphone C is set in the containing groove 22, the electrical contacting area 131 may be butted together with the contact C1 to charge the carphone C. Therefore, two contacting plates 71 are respectively arranged on the opposite sides of two mounting blocks 6, and the electrical connection position of the electrical contacting area 131 is led out to the outside of the containing groove 22 by the connecting portion 7. In order to facilitate the operator to install the charging device, two contacting plate 71 may be directly set at intervals to feed the current into two electrical contacting areas 131. Furthermore, the component of the charging device is simplified, and the cooperation of the bearing structure 4 and the power supply component 9 may adapt to different forms of installation structures. Moreover, the two contacting plates 71 are provided with a spacing, which may avoid the occurrence of short circuit when the feeding equipment is connected with the two electrical contacting areas 131.

In another optional implementation, the charging device in the above embodiment may be applied to the carphone component. The carphone component in this embodiment also includes carphones C. Each earphone C includes a contact C1, and the earphone C compresses conductive arm 1 through electrical contacting area 131, and bends and deforms until the carphone C is set in containing groove 22, and contact C1 is in contact with electrical contacting area 131.

To sum up, the carphone component in this embodiment is provided with an electrical contacting segment 13, a first deformation section 11 and a second deformation section 12 on the conductive arm 1, and an electrical contacting area 131 is arranged at the end of the electrical contacting segment 13. Therefore, on the one hand, the second deformation section 12 may drive the electrical contacting segment 13 away from the containing groove 22, so that carphone C may avoid the space in the containing groove 22. On the other hand, when the conductive arm 1 is not compressed, the electrical contacting area 131 is located on the inner side of the containing groove 22, and makes the conductive arm 1 tilt to the bottom of the containing groove 22. It is helpful to transform the downforce generated by carphone C into the driving force acting on electrical contacting segment 13. At the same time, when the tilt amplitude of the first deformation section 11 at the electrical contacting segment 13 is reduced to a predetermined range, under the continuous push of the carphone C, part of the first deformation section 11 is stretched and deformed, so as to drive the electrical contacting area 131 to move towards the open end 221, thereby raising the position of the electrical contacting area 131, so that the electrical contacting area 131 may be butted with the contact C1. On the other hand, the first deformation section 11 and the second deformation section 12 produce stretching deformation and bending deformation respectively. On the premise of increasing the deformation amplitude of the conductive arm 1, the elastic force exerted by the conductive arm 1 on the carphone C is limited, and the service life of the conductive arm 1 is improved.

In some embodiments, as shown in FIGS. 11 to 15, the carphone C also includes the carphone head C2 and the carphone stem C3. The carphone stem C3 is arranged on the carphone head C2 and includes the peripheral side C31 and the bottom surface C32. The contact C1 is set at the peripheral side C31, which extends from the bottom surface C32 to the carphone head C2, and the bottom surface C32 bends away from the carphone head C2. The bottom surface C32 has a first position C41 and a second position C42, and the first position C41 is far away from the carphone head C2 relative to the second position C42.

When the carphone stem C3 is close to the bottom of the containing groove 22, the electrical contacting segment 13 slides from the first position C41 to the second position C42, and then from the second position C42 to the peripheral side C31. And when the electrical contacting segment 13 slides from the second position C42 to the peripheral surface C31, the tilt amplitude of the electrical contacting segment 13 decreases.

The diameter of the bottom of the carphone stem C3 in this embodiment gradually increases. When the carphone stem C3 contacts the electrical contacting segment 13, the direction of the force exerted by the carphone stem C3 on the electrical contacting segment 13 gradually changes, and then the height of the electrical contacting arca 131 is raised by matching with the second curved segment A2.

The above description is only a preferred embodiment of the present application and is not intended to limit the present application. For those skilled in the art, the present application may have various modifications and variations. Any modifications, equivalent substitutions, improvements, etc. made within the spirit and principles of this application should be included within the scope of protection of this application.

What is claimed is:

1. A charging device, comprising:
a bearing structure comprising a housing portion, the housing portion having a containing groove; and
a power supply component comprising a conductive arm, a connecting portion, and a feeding portion, the conductive arm comprising an electrical contacting area in an extending direction, the electrical contacting area being exposed on an inner side of the containing groove, the connecting portion comprising two contacting plates, the two contacting plates being electrically connected to two electrical contacting areas respectively, the feeding portion comprising two paired feeding spring sheets, the two feeding spring sheets being disposed between the two contacting plates, the two feeding spring sheets being electrically lapped with the two contacting plates respectively, and the two feeding spring sheets being curved toward opposite sides and spaced apart.

2. The charging device according to claim 1, wherein the feeding portion further comprises:
a circuit board comprising multiple feeding areas, the feeding spring sheets being vertically disposed on the feeding areas;
wherein the feeding spring sheets comprise sixth curved segments, each sixth curved segment has an abutting surface, two sixth curved segments are curved in directions away from each other;
in a free state of the feeding spring sheets, a spacing between two abutting surfaces is greater than a spacing between the two contacting plates, the two abutting surfaces are in an abutting state with the two contacting plates respectively, and the two feeding spring sheets are curved and deformed toward opposite sides.

3. The charging device according to claim 2, wherein the connecting portion further comprises two strip-shaped conductors, each strip-shaped conductor comprises a first connecting end, a second connecting end, and an extending section located between the first connecting end and the second connecting end;
two extending sections are attached to different regions of an outer side surface of the housing portion, two first connecting ends are connected to the two contacting plates respectively, and two second connecting ends are electrically connected to the two electrical contacting areas respectively.

4. The charging device according to claim 3, wherein the bearing structure further comprises two mounting blocks and multiple positioning members, the two mounting blocks are projected on the outer side surface of the housing portion, the two mounting blocks are oppositely arranged, the multiple positioning members are projected on the two mounting blocks, each positioning member comprises a column and multiple flanges, the multiple flanges are projected on a lateral side of the column;
the two contacting plates are disposed on opposite sides of the two mounting blocks and spaced apart, the first connecting end has a positioning hole, the column extends into the positioning hole, and the multiple flanges are clamped on an edge of the positioning hole.

5. The charging device according to claim 4, wherein the containing groove has an open end;
each mounting block has a first mounting surface, a second mounting surface, and an edge rib located between the first mounting surface and the second mounting surface, two first mounting surfaces are oppositely arranged, a direction of the second mounting surface is opposite to a direction of the open end, the edge rib is disposed on a side of the first mounting surface close to the circuit board;
the first connecting end is disposed on the second mounting surface, the two contacting plates are disposed on the two first mounting surfaces respectively, and edges of each contacting plate cover at least a portion of corresponding edge rib and extend to the first connecting end;
each sixth curved segment further comprises a guiding inclined surface, the guiding inclined surface is located on a side of the abutting surface away from the circuit board, two guiding inclined surfaces are inclined toward opposite sides, and in the free state of the feeding spring sheets, a spacing between the two guiding inclined surfaces is the same as a spacing between the contacting plates located at two edge ribs.

6. The charging device according to claim 5, wherein the power supply component comprises two conductive arms, the conductive arm further comprises a fixing section and a feeding end, the fixing section is located between the electrical contacting area and the feeding end, the fixing section is fixedly connected to the bearing structure;
in a free state of the conductive arm, an end of the conductive arm provided with the electrical contacting area extends into the containing groove, the feeding end and the second connecting end are located on a side of the bearing structure away from the open end, and the second connecting end is electrically connected to the feeding end.

7. The charging device according to claim 6, wherein the housing portion further comprises a positioning concavity, the positioning concavity is opposite to a direction of the containing groove;
the charging device further comprises a positioning portion, the fixing section is disposed in the positioning concavity via the positioning portion, the positioning portion is an injection-molded part, the fixing section is disposed within the positioning portion, and the feeding end extends out from the positioning portion.

8. The charging device according to claim 7, wherein a side of the positioning portion close to the open end is attached to a bottom surface of the positioning concavity, a side away from the open end forms an adhesive groove with the positioning concavity, and the feeding end extends from an inner side to an outer side of the adhesive groove;
the charging device further comprises an adhesive, the adhesive fills the adhesive groove.

9. The charging device according to claim 8, wherein the connecting portion further comprises multiple solder blocks;
wherein a top of the cured adhesive is flush with a top of the adhesive groove;
the second connecting end has a connecting hole, the second connecting end extends from a top edge of the adhesive groove to the top of the adhesive, the connecting hole is sleeved on the feeding end, the second connecting end is fixedly connected to the adhesive and the feeding end via the solder blocks, and the second connecting end is electrically connected to the feeding end.

10. The charging device according to claim 5, wherein the housing portion further comprises two limiting grooves communicating with the containing groove;
the electrical contacting area compresses the conductive arm to bend and deform, and in a state where the conductive arm abuts against an inner wall of the limiting groove, the conductive arm drives the electrical contacting area to move in a direction away from the open end.

11. The charging device according to claim 5, wherein the second mounting surface is planar and has multiple grooves, the positioning members are protruded at bottoms of the grooves;
the first connecting end is attached to the second mounting surface, and the multiple positioning holes are spaced apart and correspond to the bottoms of the multiple grooves.

12. A charging device, comprising:
a bearing structure comprising a housing portion and two mounting blocks fixedly connected to the housing portion, the housing portion having a containing groove, the two mounting blocks being oppositely arranged; and
a power supply component comprising a connecting portion and two electrical contacting areas, the two electrical contacting areas being exposed on an inner side of the containing groove, the connecting portion comprising two contacting plates, the two contacting plates being electrically connected to the two electrical contacting areas respectively, and the two contacting plates being disposed on opposite sides of the two mounting blocks and spaced apart.

13. The charging device according to claim 12, wherein the housing portion further comprises:
a first housing having the containing groove, the containing groove being provided with two windows; and
two second housings integrally formed with the first housing and located on a side of the first housing away from the open end, the second housings and the first housing forming limiting grooves and positioning concavity, the two limiting grooves communicating with the containing groove via the two windows respectively;
wherein the two mounting blocks are projected on the first housing, the two mounting blocks are staggered with the two second housings in a cross-sectional direction of a depth of the containing groove.

14. The charging device according to claim 13, wherein the first housing comprises a first side wall and a first end wall opposite to the open end, the first side wall surrounds the first end wall to form the containing groove, an end of the first side wall close to the first end wall is provided with the windows;
the second housing comprises a second side wall and a second end wall, a thickness direction of the second end wall is consistent with a depth direction of the containing groove, the second side wall extends from the second end wall along the depth direction of the containing groove to a side of the first end wall away from the open end, the second side wall comprises a first part and a second part in an extending direction, the first part forms the limiting groove with the second end wall and the first end wall, an inner wall of the second part is a long waist hole, the second part is located on the side of the first end wall away from the open end, and the second part forms the positioning concavity with a portion of the first end wall.

15. The charging device according to claim 14, wherein the two second housings correspond to the two mounting blocks respectively;
in the cross-sectional direction of the depth of the containing groove, two extending sections extend along an outer side surface of the first housing in opposite directions.

16. The charging device according to claim 15, wherein each extending section comprises a first segment and a second segment, the first segments of the two extending sections are attached to the outer side surface of the first housing and extending in opposite directions, the second segment is attached to an outer side surface of the second side wall and extends along the depth direction of the containing groove, one end of the second segment extends to an edge of the second side wall away from the second end wall and is connected to the second connecting end, and another end of the second segment is connected to one end of the first segment, another end of the first segment extends to a bottom of the mounting block and is connected to the first connecting end.

17. The charging device according to claim 12, wherein the charging device comprises two bearing structures, and the power supply component further comprises a feeding portion;
the feeding portion comprises feeding spring sheets and a circuit board, the circuit board comprises four feeding areas, the feeding spring sheets form two pairs of feeding spring sheets, the two pairs of feeding spring sheets correspond to the two bearing structures respectively, and the two pairs of feeding spring sheets are disposed on the four feeding areas.

18. A charging device, comprising:
a housing portion having a containing groove, the containing groove having an open end; and
a conductive arm comprising a first deformation section, a second deformation section, and an electrical contacting segment in an extending direction, the first deformation section being connected between the second deformation section and the electrical contacting segment, an end of the electrical contacting segment having an electrical contacting area;
wherein, in a free state of the conductive arm, the electrical contacting area is located in the containing groove, and an end of the electrical contacting segment provided with the electrical contacting area is inclined toward a bottom of the containing groove;
the electrical contacting segment drives the conductive arm to elastically deform, the second deformation section bends and deforms to drive the electrical contacting segment to move in a direction away from the containing groove, and a portion of the first deformation section stretches and deforms to drive the electrical contacting area to move toward the open end.

19. The charging device according to claim 18, wherein the housing portion further has a limiting groove, the limiting groove communicates with the containing groove, an inner wall of the limiting groove comprises a limiting surface;
the second deformation section is disposed in the limiting groove, the electrical contacting segment extends from the limiting groove into the containing groove;
the conductive arm bends and deforms and abuts against the limiting surface, and the electrical contacting area moves from the containing groove toward the limiting groove.

20. The charging device according to claim 19, wherein the limiting surface comprises a first limiting surface, the first limiting surface is located on a side of the limiting groove close to the containing groove and extends along a depth direction of the containing groove;
the second deformation section comprises a first curved segment, the first curved segment is curved toward the first limiting surface, and the second deformation section is located on a side of the first deformation section away from the open end.

21. The charging device according to claim 20, wherein the first deformation section comprises a second curved segment, in the extending direction of the conductive arm, the second curved segment is located between the first curved segment and the electrical contacting segment, the second curved segment is curved in a direction away from the containing groove.

22. The charging device according to claim 21, wherein the limiting surface further comprises a second limiting surface, the second limiting surface is spaced apart from the first limiting surface and faces the containing groove;
the first deformation section further comprises a third curved segment, in the extending direction of the conductive arm, the third curved segment is located between the electrical contacting segment and the second curved segment, the electrical contacting segment extends from the third curved segment to the containing groove;
the second curved segment stretches and deforms until the third curved segment abuts against the second limiting surface, and the first curved segment is in an abutting state with the first limiting surface.

23. The charging device according to claim 22, wherein the limiting surface further comprises a third limiting surface, the third limiting surface is opposite to a direction of the open end and located on a side of the limiting groove close to the open end, the third curved segment is curved toward the third limiting surface.

24. The charging device according to claim 22, wherein the second limiting surface extends along the depth direction of the containing groove, and a portion of the second limiting surface is opposite to the first limiting surface;
the second deformation section further comprises a first connecting segment, the first connecting segment is connected between the first curved segment and the second curved segment;
the first curved segment and the second curved segment are in an abutting state with the limiting surface, the first connecting segment is located between the first limiting surface and the second limiting surface;
wherein the charging device further comprises a positioning portion;
the second deformation section further comprises a second connecting segment, a third connecting segment, and a fourth curved segment connected between the second connecting segment and the third connecting segment, the first curved segment is connected between the first connecting segment and the second connecting segment, the third connecting segment extends from the fourth curved segment to the positioning portion, and the conductive arm is disposed on the housing portion via the positioning portion.

25. The charging device according to claim 22, wherein the first deformation section further comprises a fifth connecting segment, the third curved segment is connected between the electrical contacting segment and the fifth connecting segment, and the fifth connecting segment is connected between the third curved segment and the second curved segment.

26. The charging device according to claim 22, wherein the conductive arm is a strip-shaped structure, a bending direction of the conductive arm is perpendicular to a width direction of the strip-shaped structure, and widths of the first curved segment, the second curved segment, and the third curved segment decreases sequentially.

27. The charging device according to claim 22, wherein the electrical contacting area is located at an end of the electrical contacting segment away from the third curved segment, and the electrical contacting area is an arc surface;
the first deformation section further comprises a free segment, the free segment is disposed at an end of the electrical contacting segment away from the third curved segment and is curved in a direction away from the electrical contacting area;
the electrical contacting area is curved in a direction away from the second limiting surface.

28. The charging device according to claim 19, wherein the conductive arm further comprises a fixing section and a feeding end, the second deformation section is located between the first deformation section and the fixing section in the extending direction of the conductive arm, and the feeding end is located at an end of the fixing section away from the second deformation section.

29. The charging device according to claim 28, wherein the fixing section comprises:
two fifth curved segments and a fourth connecting segment connected between the two fifth curved segments, bending directions of the two fifth curved segments being opposite, the feeding end being disposed at an end of one of the fifth curved segments, and the second deformation section extending from the other fifth curved segment to the limiting groove.

30. The charging device according to claim 19, wherein the containing groove has two windows, two limiting grooves communicate with the containing groove via the two windows respectively;
two conductive arms extend into the containing groove via the two windows respectively, and width directions of the two conductive arms are perpendicular.
